(19) United States
(12) Patent Application Publication
(10) Pub. No.: US 2004/0021552 A1
(43) Pub. Date: Feb. 5, 2004

(54) Method, device, and system for door lock

(76) Inventor: Hong-Sik Koo, Eunpyung-ku (KR)

Correspondence Address: Kevin J Canning, Lahive & Cockfield, 28 State Street, Boston, MA, 02109, US

(21) Appl. No.: 10/343,850

(22) PCT Filed: Aug. 3, 2001
(86) PCT No.: PCT/KR01/01318

(30) Foreign Application Priority Data
Aug. 3, 2000 (KR) 2000/45072

(51) Int. Cl. E05B 49/00

(52) U.S. Cl. 340/5.53; 340/5.61; 340/5.65

(57) ABSTRACT

Finger print codes of administrators are registered to card keys and locks. One of the administrators assigns a card key to a lock and enables the card key. An user registers his linger print to the enabled card key. The user inputs his finger print to the card key whenever he wants to open a lock. The card key transmits the finger print codes of administrators to the lock when the inputted finger print matches the registered finger print of the user. The lock compares the received finger print codes with the registered finger print codes. When any of the received codes matches any of the registered linger print codes, the lock is opened.

### TECHNICAL FIELD OF THE INVENTION

The present invention relates to a method, device, and system for door lock, and, in particular, to a method, device, and system for door lock using portable fingerprint recognition keys.

### BACKGROUND OF THE INVENTION

A door lock of recent days is designed so complicated and solidly that unlocking thereof without a key is almost impossible. In addition, the keys for locking and unlocking a door lock are also designed so complicated and variously that unlocking of different locks by a single universal key has become difficult. However, the problem with such conventional keys are that they can easy get lost and that they can easily be copied

Furthermore, if a plural of doors shall be controlled as it is the case in a hotel or an office building, administration of the keys is not easy, because different doors require different keys. For instance, when an administrator or a staff of a hotel has to look for different rooms, he or she must carry all the keys for these rooms. Alternatively, an ID card for storing user information, such as personal identification card, is used for better security. However, this ID card fails to control admission of an unauthorized person once an authentication is given to the authorized user. This ID card is likely to be misused as well when it is borrowed and used by a third person.

In order to overcome these problems with the metallic keys, devices for substitution of the metallic keys are being developed in recent days utilizing techniques in passwords, voice recognition, fingerprint recognition, iris recognition, etc.

As a lock device using fingerprint information, door locks equipped with user authentication means through fingerprint information are provided. Such a lock device comprises a fingerprint recognition sensor for sensing the fingerprint of a person at the outside of the door, a fingerprint stoning means for the fingerprint patterns after the signal recognized by the fingerprint sensor has been encoded, a door lock control means for control of the door lock based on the comparison between the processed fingerprint pattern and the stored pattern, and a door lock driver for performing the lock/unlock operation in accordance with the door lock control means.

However, a door lock equipped with a fingerprint recognition sensor is incapable of authenticating a user without prior registration of the fingerprint information of that user, and, even when an authorized user with registered fingerprint information allows a third person to enter, this third person cannot enter the door without company of the registered user. Thus, such a device is mainly used for doors of a house or small office having almost fixed users. Another problem with this device is that the fingerprint recognition sensor is easily soiled and or damaged due to its external exposure.

To be compatible for use in a big building with a large number of users, the door locks with fingerprint recognition sensors shall require large store capacity for storing fingerprints information of the increased number of the users. Moreover, the fingerprint recognition procedure will take a much longer time as the comparison of a fingerprint with the huge fingerprint information would be required.

Although an administrator of a hotel or other lodging facilities can respond to the changing situations by registering new fingerprints or erasing old ones, the administrator's way to the corresponding door and updating of the fingerprint information at the door cannot be saved for each change of a user.

Furthermore, since the fingerprint information and the access information are registered by the fingerprint recognition lock device, to which information the administrator has free access, the personal information on the users of such lodging facilities is protected insufficiently.

### DETAILED DESCRIPTION OF THE INVENTION

The present invention, conceived in view of the above problems, aims to provide an electronic card key which is capable of authenticating the users utilizing the fingerprints information, capable of storing fingerprint(s) of one or more users, capable of locking/unlocking one or more doors, and capable of storing the date(s) and time of locking/unlocking of the door(s).

The present invention aims further to provide a door lock device which is capable of being locked/unlocked by one or more of the above electronic card key using the fingerprints information, and is capable of storing the date(s) and time of locking/unlocking of the door(s) and the access information of the users.

It is another objective of the present invention to provide an electronic card key administration system consisted of host computer systems for administration of a plural of the electronic fingerprint recognition card keys.

Another objective of the present invention is to provide an access control method using the above electronic fingerprint recognition card key and the above door lock device.

Another objective of the present invention is to provide an access control method using not only the above electronic fingerprint recognition card key and the above door lock device, but the whole of the above system including the above electronic card key administration system.

Another objective of the present invention is to provide an electronic card key which is capable of registering fingerprint(s) of one or more users, capable of authenticating the users utilizing the fingerprints information, capable of locking/unlocking one or more doors, and capable of storing access information of the user(s).

Another objective of the present invention is to provide a door lock system which is capable of being locked/unlocked by one or more of the above electronic card keys using the fingerprint information, and is capable of confirming both the number of the people who access using a sensor and the users' authorization for access through exchange of information with the electronic card key(s) of the user(s).

Still another objective of the present invention is to provide a method for door locking/unlocking and for user authentication, which method is capable of allowing only authorized users to unlock the doors, and is capable of detecting and alerting passages of an unauthorized user after the door has initially been opened in due course.

In order to achieve these objectives, the present invention uses a portable electronic card key to be carried by the user. The electronic card key comprises a fingerprint recognition part for recognition of the fingerprints; an input part allowing the user to select a function; a data transceiver part for exchange of the information with the door lock device; a data storage part for storing the key administration code which is the unique code of the electronic card key, an administrator code corresponding to one or more electronic card key administrator(s), one or more door code(s) to which accesses are allowed, and the fingerprint code(s) corresponding to the fingerprint(s) of the users allowed to access; and a control part which transmits the administrator code and the access allowed door codes stored in the above data storage part through the above data transceiver part when the fingerprint of the user as recognized by the above fingerprint recognition part coincides with the user's fingerprint code stored in the above data storage part.

Each door is equipped with a door lock device. The door lock device comprises a door code indicating the door with a door lock device, a data storage part for storing one or more administrator codes representing the administrator(s) authorized to lock/unlock the door, a data transceiver part for transmission/receipt of data, a door lock driver for locking/unlocking of the door, and a door lock controller which controls the above door lock driver to unlock the door when the door code and the administrator code contained in the data received from the above data transceiver part coincide with the corresponding codes stored in the above data storage part.

In order to open a door, the user has to input his fingerprint in the electronic card key. The electronic card key transmits the stored fingerprint information of the administrator to the door lock device when the inputted fingerprint coincides with the stored fingerprint information of the user. Upon receiving the fingerprint information of the administrator, the door lock device unlocks the door, if the received fingerprint information of the administrator coincides with any one of the stored fingerprint information of the administrator. Further, it is also possible that the door lock device updates its fingerprint information of the administrator based on the received fingerprint information of the administrator. It is also possible that the electronic card key transmits an encrypted code for the administrator instead of the fingerprint information of the administrator. In such a case the encrypted code is stored in both the electronic card key and the door lock device.

The fingerprint information of the administrator and of the user can be inputted in the electronic card key either by the administrator, or by the electronic card key administration system.

In addition, in order to prevent a simultaneous passage of a multiple people by using only one electronic card key, a sensor may be installed at the door which can count the number of the people, so that an error message is released when the number of the people does not coincide with the number of the electronic card key.

### BRIEF DESCRIPTION OF THE DRAWINGS

FIG. 1a is the front view of an electronic fingerprint recognition card key in accordance with an embodiment of the present invention, while FIG. 1b is the rear view thereof FIG. 1c is the front view of an electronic fingerprint recognition card key in accordance with another embodiment of the present invention.

FIG. 2a is a block diagram showing the schematic construction of an electronic fingerprint recognition card key in accordance with an embodiment of the present invention, while FIG. 2b illustrates the information field stored in the data storage part of the electronic card key in the form of a table.

FIG. 3a is a block diagram of a door lock device in accordance with an embodiment of the present invention, while FIG. 3b illustrates the information field stored in the data storage part of the door lock device.

FIG. 4a is a block diagram showing the internal construction of an electronic card key administration system in accordance with the present invention, while FIG. 4b illustrates the type and structure of the data stored in the above key administration system.

FIG. 5 is a flow chart showing the process of the first access control method in accordance with the present invention.

FIG. 6 is a detail flowchart for the step of administrator fingerprint registration and reference information setting in FIG. 5.

FIG. 7 is a detail flowchart for the step of user fingerprint registration in FIG. 5.

FIG. 8 is a detail flowchart for the step of user authentication at the electronic card key and information transmission to the door lock device in FIG. 5.

FIG. 9 is a detail flow chart for the step of door locking/unlocking in FIG. 5.

FIG. 10 is an overall flowchart for the second access control method in accordance with the present invention.

FIG. 11 is a detail flowchart for the step of administrator fingerprint registration by the electronic card key administration system in FIG. 10.

FIG. 12 is a flowchart showing the step of erasing a registered administrator fingerprint by the electronic card key administration system.

FIG. 13 is a detail flowchart showing the step of administrator authentication and inputting the use information of the electronic card key in FIG. 10.

FIG. 14 is a detail flowchart for the step of transmitting the reference information to an electronic card key as illustrated in FIG. 10.

FIG. 15 is a detail flowchart for the step of updating the reference information of the electronic card key based on the reference information data frame received by the electronic card key.

FIG. 16 illustrates the step of erasing internal information of the electronic card key by an administrator or a user.

FIG. 17 illustrates the construction of a door lock system using an electronic fingerprint recognition card key in accordance with another embodiment of the present invention.

FIG. 18 shows the data structure used as the door lock information in the door lock system in FIG. 17 in the form of a table.

FIG. 19a is a detail block diagram for the door lock device of the door lock system in FIG. 17.

FIG. 19b is shows the information field stored in the data storage part of the door lock device in FIG. 19a.

FIG. 20 is a flowchart showing the first door lock method and user confirmation method of the door lock system in accordance with another embodiment of the present invention.

FIG. 21 is a flowchart showing the second door lock method and user confirmation method of the door lock system in accordance with another embodiment of the present invention.

FIG. 22 is a detail flowchart showing the steps of user authentication as well as confirming the number of the persons passing the door, and storing the access information after opening of the door in accordance with the above first and second methods as described in FIGS. 20 and 21, respectively.

### DESCRIPTION OF THE PREFERRED EMBODIMENTS

The preferred embodiments of the present invention are described below in detail making reference to the drawings.

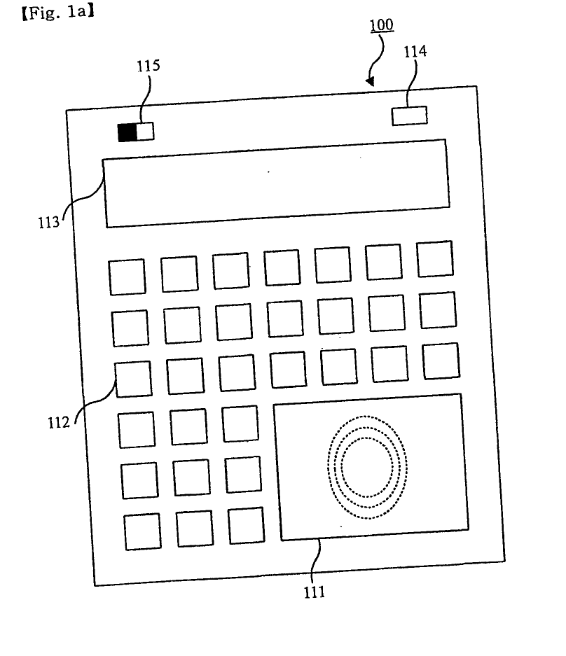

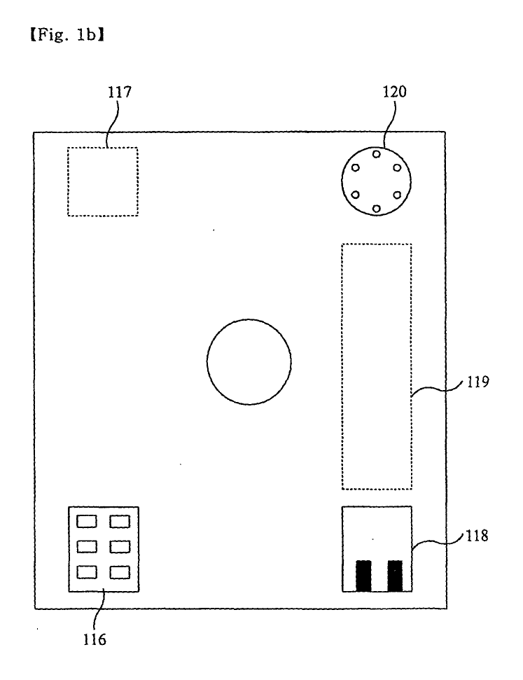

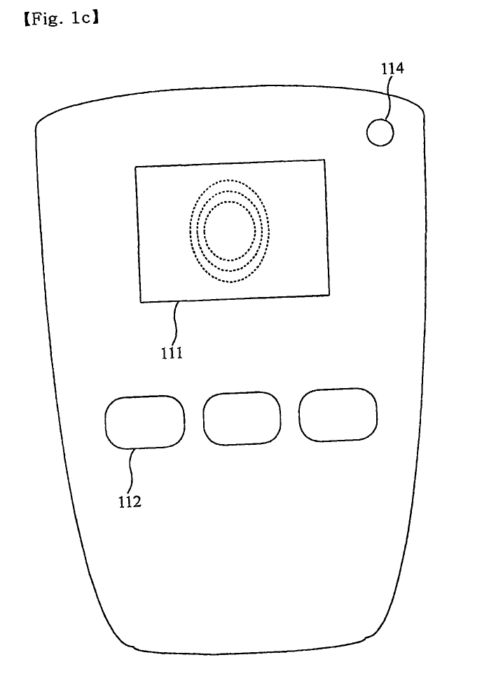

FIG. 1a illustrates the front view of an electronic fingerprint recognition card key 100 in accordance with an embodiment of the present invention.

The electronic card key 100 comprises on the front part (FIG. 1a) a fingerprint recognition part 111 for recognition of fingerprints; a keypad 112 for entering passwords, user information, etc.; a display unit 113 for displaying the input contents or the status of performance; a lamp 114 for visible showing of the operation signals; and an on/off power switch 115. On the rear part (FIG. 1b), the electronic card key comprises a data transceiver part consisted of a contact-type I/O terminal 116 capable of transmitting/receiving information by accessing an external device, and a RF transceiver part 117; a power supply terminal 118 for supplying power from an external device; a rechargeable drycell case 119 which charges the power from the power supply terminal 118; a speaker unit 120 for generating audio signals for the operation signals, and the like. Furthermore, although not illustrated, a cover can be added on the front part for protection of the fingerprint recognition part 111, keypad 112, display 113, etc.

Moreover, it is also possible that the keypad 112 comprises only important function keys, and/or the display unit 112 or the power on/off switch 115 is omitted for convenience of the transport. FIG. 1c shows another embodiment of the electronic card key based on such omission.

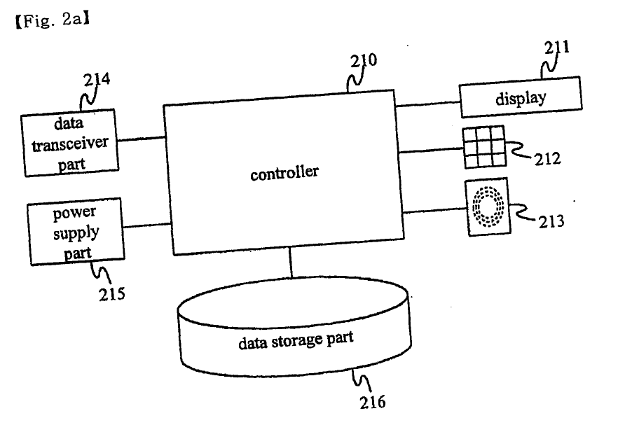

FIG. 2a is a block diagram showing the schematic construction of an electronic fingerprint recognition card key in accordance with an embodiment of the present invention. The electronic card key 100 in accordance with the present invention comprises fingerprint recognition part 213 for recognition of the fingerprints; a data transceiver part 214 consisted of a contact-type I/O terminal capable of transmitting/receiving information by accessing an external device (external door lock device and the electronic card key administration system), and a RF transceiver part; a display unit 211; an input keypad 212; a data storage part 216; and a controller 210 for control of the above components.

The controller 210 extracts the characteristics such as the ridge, valley, ending point, bifurcation point, short ridge or island, enclosure or lake, cross over, etc. of a fingerprint using the images of a recognized fingerprint; identifies a fingerprint based on the minutia of a fingerprint thus extracted; and produces a binary code (fingerprint code) peculiar to each fingerprint. This fingerprint recognition and fingerprint code production function should performed not only by the electronic card key, but also by the electronic card key administration system in which the fingerprint information of the administrators shall be inputted, as a detailed explanation thereof will follow later. The controller 210, to be composed of a 8 bit or 16 bit microprocessor equipped with a counter (or a clock), an interrupter, a serial or parallel port, etc., comprises memory components such as EPROM which stores an operating system and application programs, and a small volume data memory.

The technique of extracting fingerprint images and identifying a fingerprint, being a technique widely used currently, has been disclosed inter alia by U.S. Pat. No. 6,041,133. Further, the technique of analyzing the ridge-vector of a fingerprint after scanning of the fingerprint image and producing a unique code therefore has been disclosed in U.S. Pat. No. 6,002,787 (Fingerprint analyzing and encoding system).

The data transceiver part 214 which is used for exchange of data with the door lock device 310 or the key administration system, may be constructed as a conventional contact-type magnetic bar, but may preferably be made as a contactless RF transceiver for convenience of the users. The data storage part 216 may be composed of a small capacity (several k-bytes) flash memory, RAM, etc.

The electronic card key 100 to be used as a key in the present invention, is not limited to the function of access control, but rather, can include other functions of a conventional electronic card, e.g. a calculator, an electronic note book, a simple game machine.

The information to be stored in the data storage part 216 of the electronic card key 100 comprises in the main three types as shown in FIG. 2b, namely, the reference information 220, fingerprint information of the users 230, and access information 240.

The reference information 230 comprises a key administration code which is unique to each electronic card key 100, fingerprint information of the administrator, access allowed door code(s), information on the input date/time of the reference information, and an initialization completion code. The key administration code, to be stored in EPROM, etc. of the electronic card key 100, is generally set initially at the time of production, but may also be set by the administrator using, e.g. a dip switch. The fingerprint code of the administrator may be inputted directly by the administrator via the electronic card key 100, or it can also be stored by receiving the code stored in the administration system. The initialization completion code which has a value of either “0” or “1”, is used, as a detailed explanation thereon will follow, in determining as to whether various information stored in the electronic card key 100 shall be renewed (corresponding to “1”), or the user shall be recognized as identical so that the access information shall be accumulated.

The user fingerprint code 230, which corresponds to the fingerprint code inputted by an authorized user in the electronic card key 100, is used for authentication of the owner of an electronic card key when a door is unlocked/locked through exchange of data between the electronic card key and the external door lock device 310. Here, the electronic card key 100 may register one or more user fingerprint code(s).

The access information table 240, comprising key administration code of a user, the number of times of access of the user, access time and date, the results of the operation, etc., can be displayed upon request of the user. Further, the personal information of users can be protected if the access information is erased by the user or the administrator at the time of returning the electronic card key.

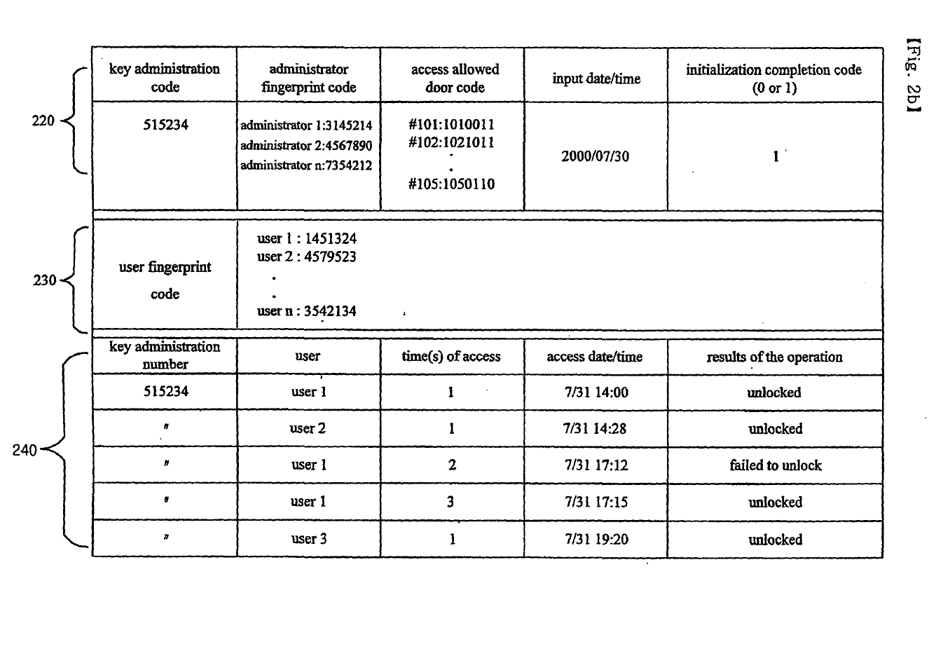

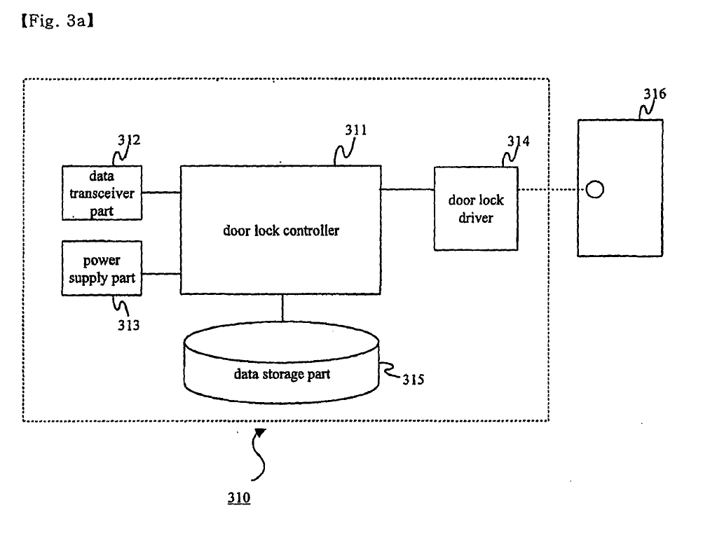

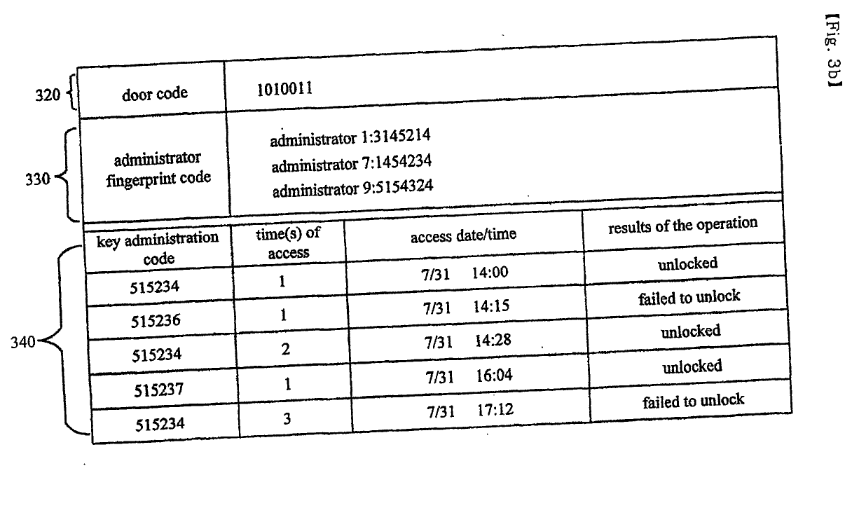

FIG. 3a is a block diagram of a door lock device to be used in the access control method in accordance with the present invention. The door lock device is consisted mainly of a data transceiver part 312 for exchange of data with the electronic card key 100, a data storage part 315, a door lock controller 311, and a door lock driver 314 which locks/unlocks the door in accordance the control signal from the above controller.

The door lock controller, which decides unlocking/locking of the door based on a comparison between the received information and a part of the data (the door code and the administrator code) stored in the data storage part, can use either an 8-bytes microprocessor of 8051 cores or a 16-bytes microprocessor of 6800 cores or more, equipped with a counter (a clock), an interrupter, a serial or parallel port, etc., and includes a ROM such as EPROM in which a program is stored for the operation of the processor.

The data transceiver part 312, which is used for exchange of data with the electronic card key 100, may be constructed as a conventional contact-type magnetic card reader, but is preferably made as a contactless RF transceiver for convenience of the users.

The data storage part, which may be composed of a small capacity (several kbytes) flash memory, RAM, etc., stores the access information (of a user) including, a door code 320, fingerprint information of the administrator 330, the number of times of access of the user, access time and date, the results of the operation, etc. as shown in FIG. 3b.

The door lock driver 314 which locks/unlocks the door in accordance with the lock/unlock signal from the door lock controller, may be composed of one or more relay driver unit(s) and solenoid driver unit(s), but is not limited thereto.

Moreover, the door lock device 310 may additionally include a display part using e.g. LCD for displaying the results of the operation, speakers, etc. Further, the access allowed door code(s), to be stored in EPROM, etc. of the door lock device, is generally set initially at the time of production, but may also be set by the administrator using, e.g. a dip switch.

As illustrated in FIG. 3b, the data storage part 315 of the door lock device 310 stores a door code 320 of a door to be driven by the device, administrators' fingerprints code 330 inputted through the electronic card key 100, times of access per key administration codes of the electronic card keys which have effected driving of the door lock device 310, access date and time, and the results of the operation. For protection of personal information, the stored access information shall be deleted every time when the user is changed (i.e. when the initialization completion code changes from “0” to “1”) even if the key administration code remains the same. Among the data stored in the data storage part 315, the door code 320 is given initially, while the administrator fingerprint information 330 and the access information 340 shall be inputted or deleted by the electronic card key 100 any time.

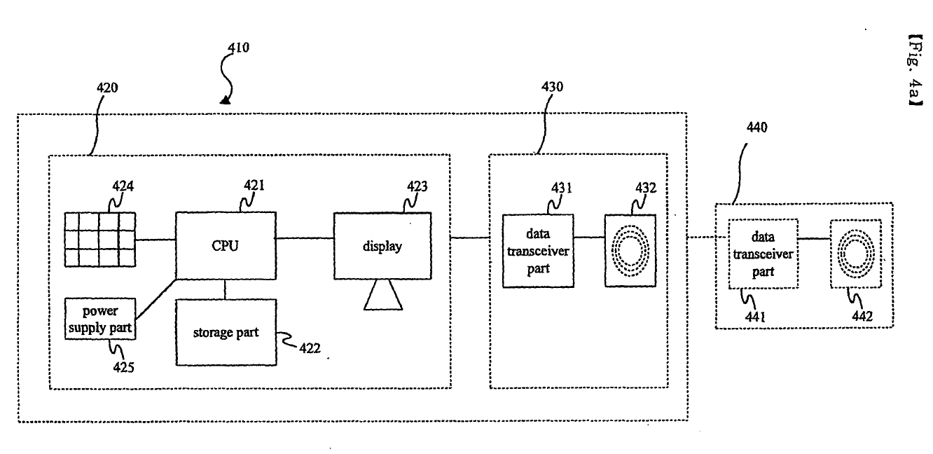

FIG. 4a is a block diagram showing the internal construction of an electronic card key administration system in accordance with the present invention. The electronic card key administration system 410 is composed of the main of a computer part 410, and an internal fingerprint input part 430 or an external fingerprint input part 440. The computer part 420, such as a conventional general PC, comprises a CPU 421, a data storage unit 422 such as RAM or hard disk, a display unit such as CRT monitor, a key board, a data input unit such as CD-ROM, floppy disk drive, and a power supply unit 425.

The internal or external fingerprint input parts 430, 440, differing from one another dependent only on their spatial locations to the above computer part, are consisted mainly of a data transceiver part 431, 441 and a fingerprint input part 432, 442. The data transceiver part 431 or 441, which is used for exchange of data with the electronic card key 100, may be constructed as a conventional contact-type magnetic card reader, but is preferably made as a contactless RF transceiver for convenience of use. The fingerprint input part 432, 442, which functions as a kind of scanner, extracts image(s) of the fingerprint and transmits this information to the CPU 421 using an internal data bus(in case of an internal fingerprint input apparatus) or a serial port (in case of an external fingerprint input apparatus).

The CPU 421 recognizes inputted fingerprint images with a program stored in it and allots a unique code to each of them, while the storage part 422 of the computer comprises key administration codes of the electronic card keys 100 administered by the computer, administrator fingerprint codes as per the key administration codes, access allowed door codes, date and time of the information inputs, initialization completion code, user information, etc., to which access information as per the key administration codes may be added. The type and structure of the data stored in the key administration system may be designed to comprise, as shown in FIG. 4b, one or more administrator fingerprint code(s) as per the key administration codes, access allowed door codes, date and time of information inputs, a table 450 including the user information, key administration codes, entered/exited doors, times of access, date and time of access, a access information table 460 including information on the entered/exited users, but not limited thereto. For example, the stored data may include only the check-in and check-out time, excluding the detailed access information, for a better protection of personal information.

FIG. 5 is a flow chart showing the process of the first access control method in accordance with the present invention, having application to a method using the electronic card key 100 and the door lock device 310 in accordance with the present application.

The main steps of the first access control method include the step of registering administrator fingerprint in the electronic card key 100 and setting of the reference information by the administrator (S510); the step of registering user's fingerprint in the electronic card key 100 (S520); the step of user authentication and transmission of this information to the door lock device by the electronic card key (S550); and the step of door locking/unlocking by the door lock device (S570). The basic principle of operation of this method is: When a user has registered his fingerprint in an electronic card key authenticated by an administrator, upon input of the user's fingerprint, the corresponding information stored in the electronic card key 100 is transmitted to the door lock device 310, so that the information transmitted from the electronic card key 100 (access allowed door codes and administrator fingerprint codes) is compared with the information stored in the door lock device 310, on the basis of which comparison a decision for locking/unlocking of the door is made. Thus, in contrast to a conventional fingerprint recognition door lock device, the door lock device 310 of the present invention neither needs to comprise a fingerprint input part in it, nor requires an administrator to renew the user information stored in it for every change of a user.

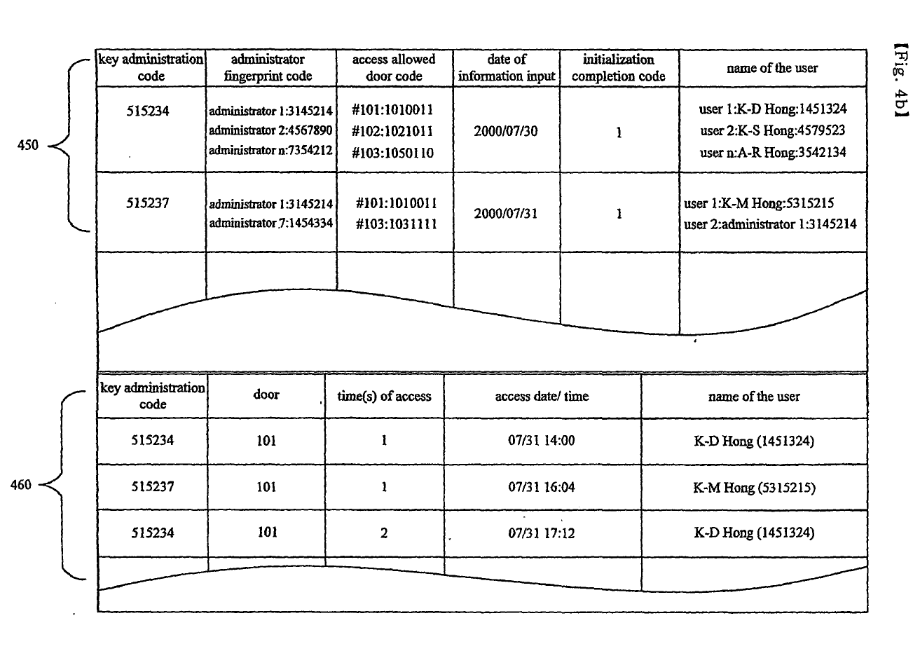

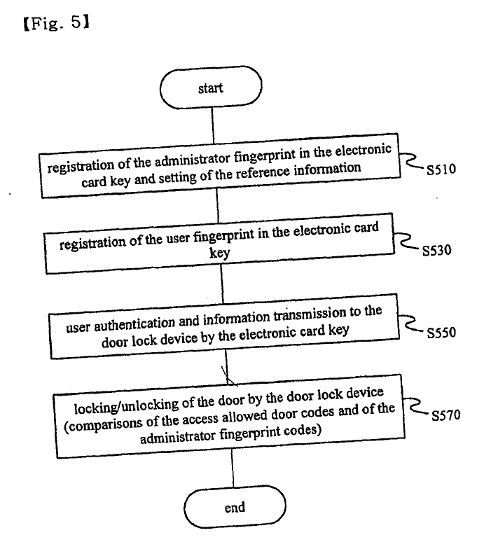

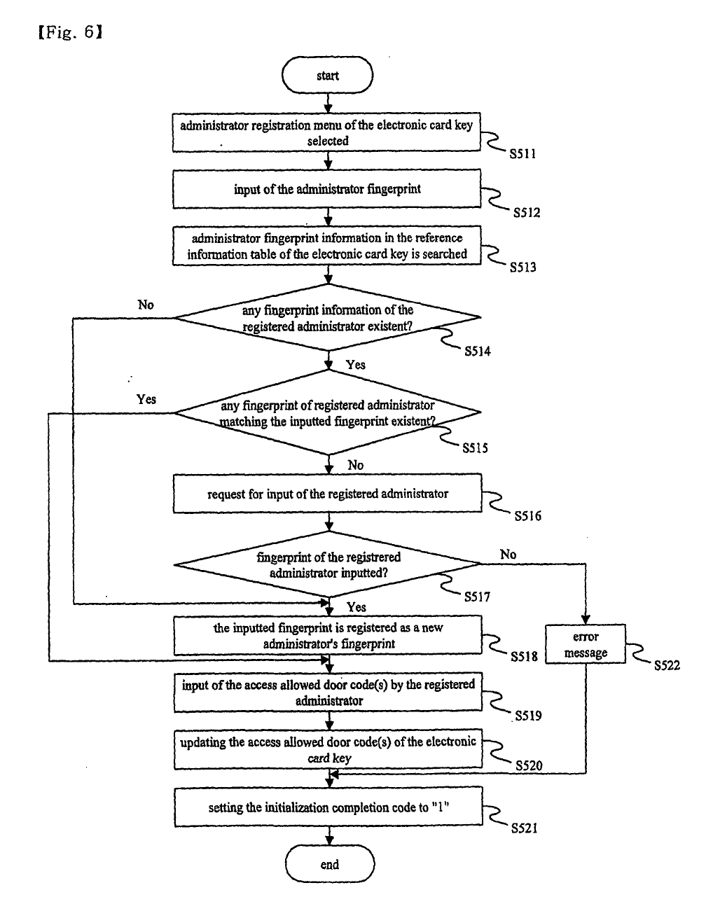

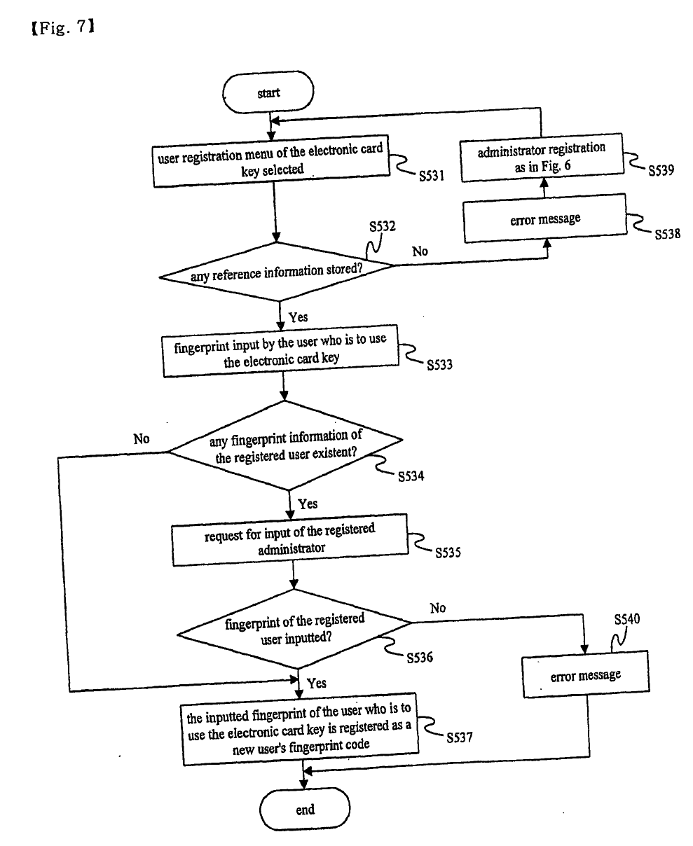

Each step in FIG. 5 is explained in detail below. In addition, FIG. 6 is a detail flowchart for the step of administrator fingerprint registration and reference information setting (S510) in FIG. 5.

The administrator selects the administrator registration menu (S511) from among the usable menu of the electronic card key, and inputs his fingerprint (S512). The controller of the electronic card key 100 extracts the unique code of the inputted fingerprint and checks if an administrator fingerprint code has already been registered by searching the registered administrator fingerprint code information (S513, S514). If no registered administrator fingerprint information exists, the inputted fingerprint is registered as the initial administrator fingerprint (S518).

If any registered administrator fingerprint code exists, the inputted fingerprint is checked whether it coincides with any one of the registered administrator fingerprint codes (S515). If no identical registered administrator fingerprint code exists, fingerprint input by the registered administrator is requested in order to confirm whether the person having inputted his fingerprint is authorized as a new administrator (S516). If the person who has inputted his fingerprint at step S512 is confirmed to be an authorized administrator through input of the registered administrator's fingerprint, the inputted fingerprint code is stored in the corresponding area of the electronic card key 100 (S518). After this authentication procedure, the administrator inputs the access allowed door codes in the electronic card key 100, whereupon the electronic card key 100 stores the access allowed door codes (S519, S520). Then, the administrator signalizes that the initialization of the electronic card key 100 has been completed by setting the initialization completion code of the reference information stored in the electronic card key 100 to “1” (S521). Alternatively, user information such as the user's name and the date/time of distribution of the electronic card key 100 may be inputted additionally.

When the initialization completion code of an electronic card key 100 is set to “1”, the door lock device 310 recognizes a new user and erases all information (access information, user information, etc.) related to the corresponding previous card key, and changes the initialization completion code of the electronic card key 100 to “0”. The use information thereafter is stored accumulated in the door lock device 310 and the electronic card key 100 until the corresponding card key is transferred to another user and the initialization completion code is changed to “1” by the administrator. In this way, the fingerprint code of an administrator is registered in the electronic card key 100 and the electronic card key 100 is initialized by the administrator's inputting of the access allowed door codes and setting of the initialization completion code.

FIG. 7, being a detail flowchart for the step of a user fingerprint registration (S530) in FIG. 5, illustrates the process of initial registration of a user fingerprint in an initialized electronic card key 100.

First, the user, after having received an electronic card key 100 from the administrator, selects the user registration menu of the electronic card key 100 (S531), whereupon the electronic card key 100 checks if any stored reference information (administrator fingerprint code, user information, information on the date and time, initialization completion code) exists (S532). In case no reference information is stored in it, the electronic card key is not recognized as an authentic card key issued by the administrator, whereupon an error message is released, and the process of administrator registration as in FIG. 6 commences (S538, S539).

In case the reference information is stored, the user's fingerprint is entered and a fingerprint code corresponding to the fingerprint image is extracted (S533). As next, it is checked whether any registered user exists (S534). If no registered user fingerprint code exists, the fingerprint code is registered as the initial user fingerprint code and stored (S537). If a registered user exists and the inputted fingerprint code does not coincide with that of the registered user, input of the fingerprint of the registered user is requested for confirming that the new user is a duly authorized user (S535). If the new user is confirmed as authorized by input of fingerprint of the registered user, the initially registered fingerprint code is then registered as the fingerprint code of the new user (S537). On the contrary, if the fingerprint of the registered user is not entered, an error message notifying the necessity of permission (confirming) by the registered user is released (S540). In this way, fingerprint codes of one or more user can be registered in an electronic card key 100, which registered fingerprint codes may be used as authentication for transmission of the data frames from the electronic card key 100 to the door lock device 310 as explained in detail below.

FIG. 8 is a detail flowchart for the step of user authentication at the electronic card key and information transmission to the door lock device (S550) in FIG. 5. A user willing to open the door selects the door lock menu or the door lock button from the menu or the buttons, respectively, of the electronic card key 100 (S551), and inputs his fingerprint (S552). If the fingerprint code of the inputted fingerprint coincides with any one of registered user fingerprint codes, the user is recognized as an authorized user, and the data transmission to the door lock device 310 proceeds. In case the user is not authenticated, an error message is released and the process terminates without unlocking the door (S560).

The data transmission to the door lock device 310 proceeds as follows: Upon authentication of a user, the electronic card key 100 sends to the door lock device 310 a transmission request asking the door lock device 310 to receive data from the card key 100 (S554). The electronic card key 100 transmits data frame consisted of the stored information comprising key administration codes, administrator fingerprint codes, access allowed door codes, etc. to the door lock device 310, if it receives a receive-ready signal from the door lock device 310 within a predetermined time limit (S555, S556). If the door has been duly opened and the results of the operation have been received within a predetermined time limit from the door lock device 310, the initialization completion code of the reference information stored in the electronic card key 100 is changed from “1” to “0” (S557, S558). This change of the initialization completion code to “0” means, as described above, that the corresponding electronic card key 100 is registered in the door lock device 310, so that the door lock device 310 stores in accumulation all access performed by the electronic card key until the electronic card key is initialized for use of another user. The final results of the operation (whether or not the door has been opened, whether or not the door could not be opened due to a non-coincidence of access allowed door code or administrator fingerprint code, etc.) are displayed to the user via the electronic card key 100 and/or the door lock device 310 (S559).

If the electronic card key 100 fails to receive a receive-ready signal from the door lock device 310 within a predetermined time limit after its transmission request, or to receive the results of the operation from the door lock device 310 within a predetermined time limit, an error message is released and the operation terminates (S560). This step aims to limit the valid time of a user authentication. If, for instance, the electronic card key gets lost when an authorized user has left the door for other urgent matter, after authentication of the user in a state when a transmission request has been sent to the door lock device 310 or the data frame has been transmitted, an unauthorized person who has unduly obtained the electronic card key 100 would freely continue the opening procedure of the door to effect an unauthorized opening of the door, without such time limitation. In order to prevent such misuse, the double limitation of validity time (for receipt of the receive-ready signal after the transmission request and for receipt of the results of the operation after the transmission of the data frame) has been introduced.

FIG. 9 is a detail flow chart for the step of door locking/unlocking (S570) in FIG. 5. The basic principle of the operation is to decide locking/unlocking of the door on the basis of the comparison between the “access allowed door codes” and “administrator fingerprint codes” of the data frame received from the electronic card key 100 with the “door codes” and “administrator codes”, respectively, stored in the door lock device 310.

To be more in detail, the door lock device 310 determines whether its door code coincide with the access allowed door code of the electronic card key 100 after having received data frame from the electronic card key 100 as in FIG. 8. (S571, S572). In other words, the door code functions as the primary “key”. If the door codes do not coincides with each other, an error message is released (or the result is transmitted to the electronic card key 100) and the operation terminates (S577, S578). If the door codes coincide with each other, it is checked whether any administrator fingerprint code is registered in the door lock device 310 for comparison of the administrator fingerprint codes (S573). If no administrator fingerprint code has been registered, which signifies that no administrator fingerprint code has yet been registered at the door lock device 310, the administrator fingerprint code of the data frame received is registered as the initial administrator fingerprint code (S574). If any administrator fingerprint code has been registered, it is determined whether the administrator fingerprint code of the received data frame coincides with any one of the administrator fingerprints registered at the door lock device 310 (S575). In case one or more administrator fingerprint codes coincide, the administrator fingerprint codes registered at the door lock device 310 are substituted by the administrator fingerprint code(s) of the data frame (S576). Having the door codes and the administrator fingerprint codes been confirmed, the electronic card key 100 is recognized as authentic, and the door can be opened. However, prior to the opening of the door, it is confirmed whether the initialization completion code of the data frame is “1” (S579): If the initialization completion code is set to “1”, which means that the owner of the electronic card key 100 is a new user, the access information relating to the corresponding key administration code (of the previous user) stored in the door lock device 310 are erased (S580); in contrast, if the initialization completion code is set to “0”, which means continuous use of the card key by the same user, the access information is stored in accumulation (S581). After completion of the above confirmation procedures, the door lock device 310 transmits the results of the process to the electronic card key 100, and opens the door driving the door lock driver (S582, S583).

The renewal of the administrator fingerprint code for each access aims to prevent unauthorized practice of an administrator's right by a person who was once an administrator, but ceased to be one. For example, if A is such a (former) administrator and the door lock device 310 stores A, B, and C as registered administrators, while A has distributed electronic card keys 100 with A's fingerprint registered as an administrator fingerprint, a user of such electronic card key 100 would be able to open the door (because both the access allowed door code and one of the administrator fingerprint codes, i.e. A's fingerprint code, match with their corresponding codes). However, this problem could be solved if the administrator fingerprints are renewed for each access. For example, if the door is opened once by an electronic card key 100 with registration of the updated administrators B, C, and D, the door lock device 310 would update the administrator fingerprint codes from A, B, and C to B, C, and D, thus would block opening of the door by an electronic card key with A registered as administrator.

In this way, the present invention can achieve its objectives, since only those electronic card keys distributed by the authorized administrators and authenticated by the authorized users can open the door, without the necessity of renewing the user information at each door lock device 310 by the administrator, and without the necessity of installing a fingerprint input part in each door lock device 310.

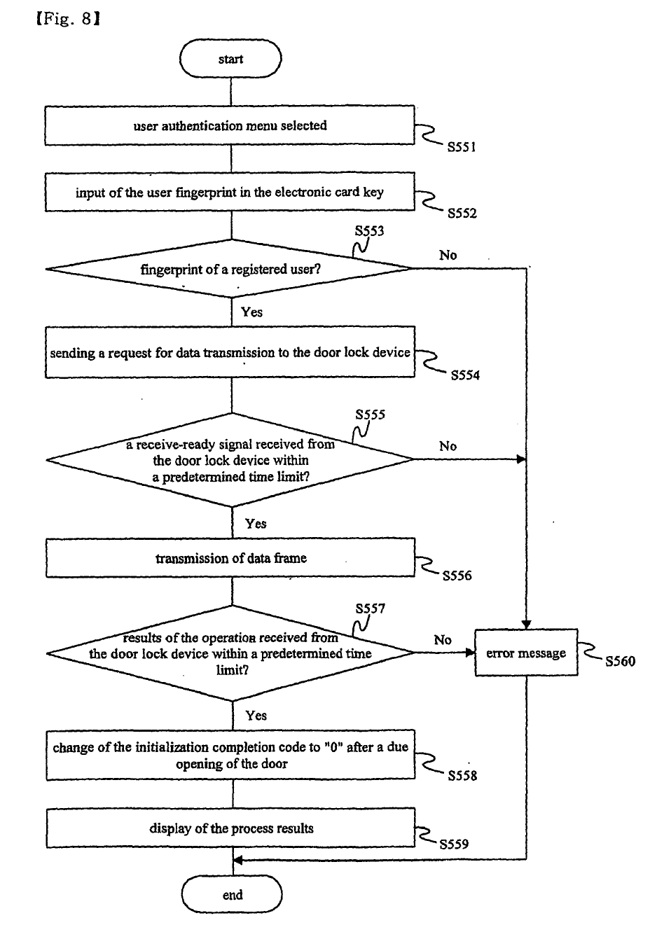

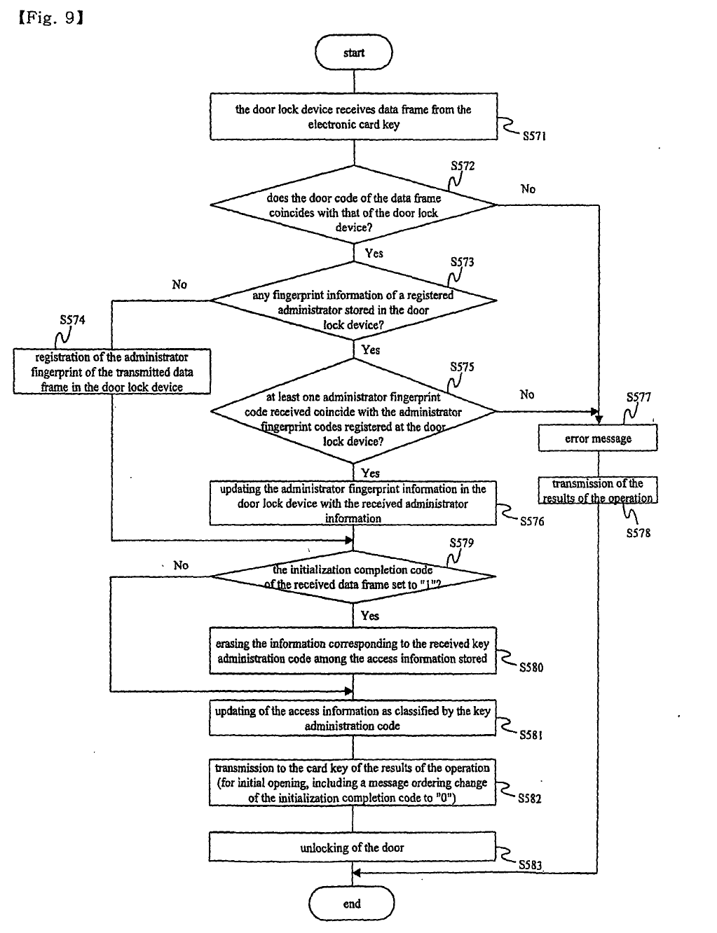

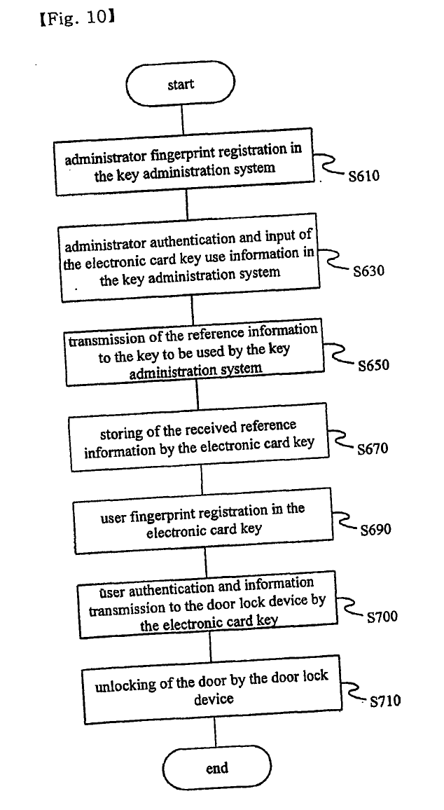

FIG. 10 is an overall flowchart for the second access control method in accordance with the present invention, wherein an electronic card key administration system is used in addition to the electronic fingerprint recognition card key 100 and the door lock device 310.

The second access control method comprises in the main the steps of administrator fingerprint registration in the electronic card key system (S610), of administrator authentication and inputting use information of the electronic card key by the electronic card key administration system (S630), of reference information transmission to the electronic card key 100 by the electronic card key administration system (S650), of storing the received reference information by the electronic card key 100 (S670), of registering the user's fingerprint in the electronic card key 100 (S690), of user authentication and information transmission to the door lock device 310 by the electronic card key 100 (S700), and of locking/unlocking of the door by the door lock device 310 (S710). Since the steps of user fingerprint registration (S690), of user authentication and information transmission (S700), and of locking/unlocking of the door (S710) are identical with those of the first access control method described above in reference to the FIGS. 6 to 9, an explanation therefore is omitted here.

Although basically similar to the first access control method, the second access control method differs from the first in that the electronic card key administration system as the central host is responsible for the administrator fingerprint registration and transmission of the reference information to the electronic card key, while in the first access control method the administrator directly inputs these information to the card key.

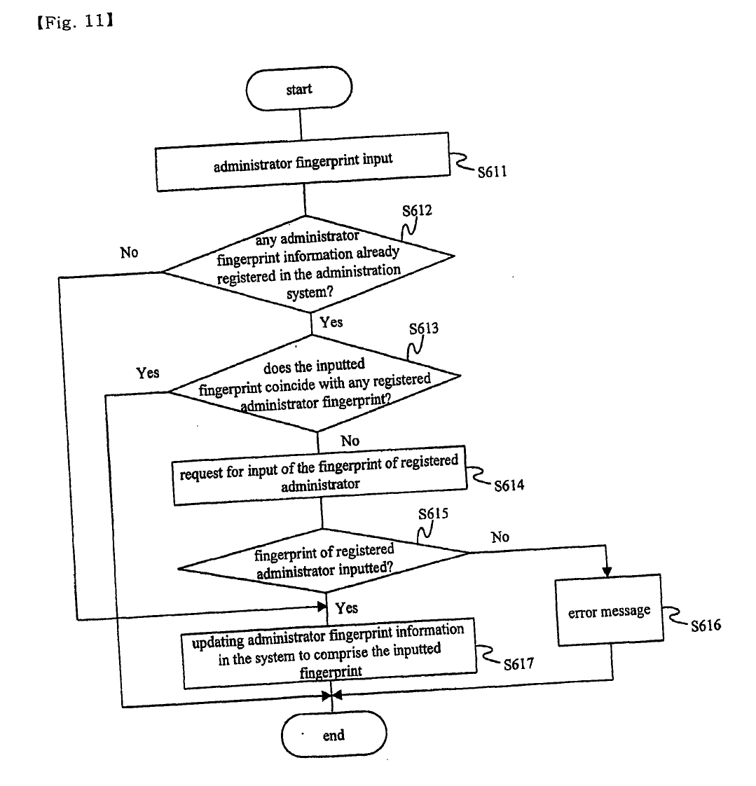

FIG. 11 is a detail flowchart for the step of administrator fingerprint registration (S610) by the electronic card key administration system in FIG. 10. The administrator accesses the key administration system and registers his fingerprint (S611). The key administration system checks whether any administrator fingerprint information is registered in the system (S612), and registers the fingerprint inputted in step S611 as an administrator fingerprint, if no administrator fingerprint has been registered (S617).

If any administrator fingerprint is registered in the system, it is checked whether the code of the fingerprint inputted in step S611 coincides with any one of the registered administrator fingerprint codes (S613). In case of non-coincidence, inputting of the registered administrator fingerprint is requested (S614) to confirm that the person who has inputted the fingerprint is an authorized administrator. Since the person who has inputted his fingerprint at step S611 is confirmed as an authorized administrator with input of a registered administrator's fingerprint, the inputted fingerprint is registered additionally as a new administrator fingerprint (Renewal of an administrator fingerprint; S615, S617). In case no registered administrator fingerprint is inputted or a false fingerprint is inputted, an error message stating an administrator fingerprint to be unregistrable, is released (S616). In this way, fingerprint codes of one or more authorized administrators can be registered in the electronic card key administration system.

FIG. 12 is a flowchart showing the step of erasing a registered administrator fingerprint code stored in the electronic card key administration system. If an administrator enters his fingerprint in the key administration system, the key administration system checks whether the inputted fingerprint matches with the fingerprint code of the registered administrator, authenticates the administrator (S621, S622), and displays the information related to that administrator in a list form (S623). Then, the administrator who has accessed the key administration system selects the number of the administrator he wishes to erase from the enlisted administrators (S624), and erases the administrator fingerprint code if the selected number exists (S625, S627). In other words, any authorized administrator can access to the key administration system and proceed, after authentication by the key administration system, to erase fingerprint information of those who have ceased to be authorized administrators.

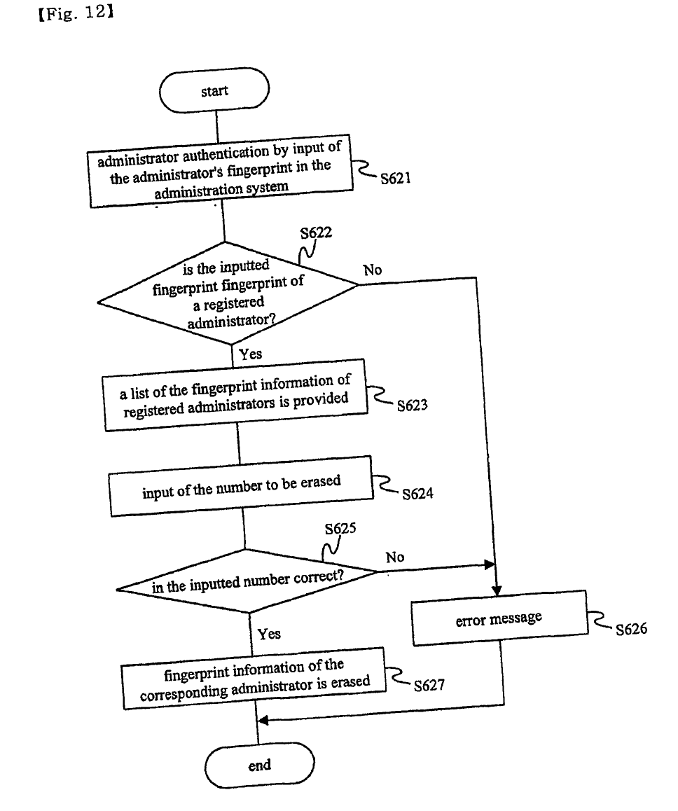

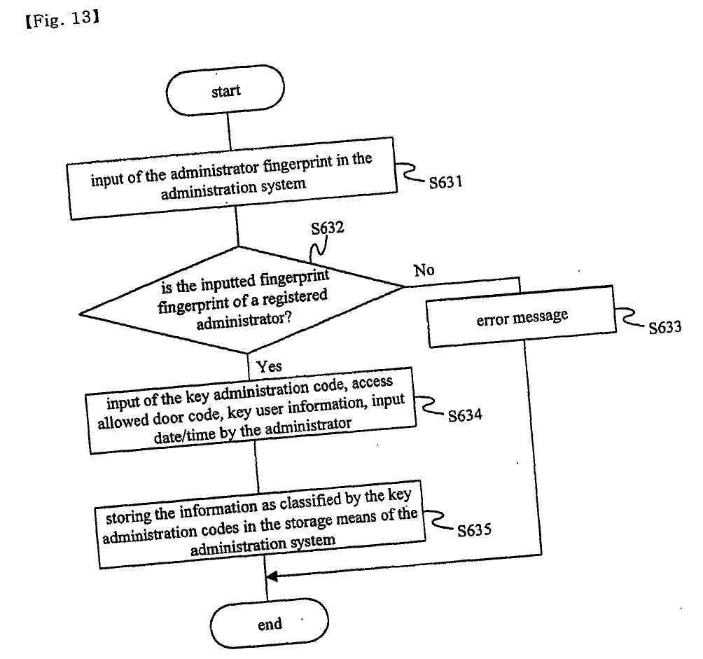

FIG. 13 is a detail flowchart showing the step of administrator authentication by the electronic card key administration system and inputting the use information of the electronic card key (S630) in FIG. 10. Here, the basic process proceeds in a manner that the administrator inputs the required information in the electronic card key 100 after the administrator has accessed the electronic card key administration system and is authenticated as an authentic administrator.

To be more specific, if the administrator accesses the electronic card key administration system and inputs his fingerprint (S631), the key administration system checks whether the inputted fingerprint code is that of a registered administrator (S632). After the administrator is authenticated to be an authentic administrator, the administrator inputs the use information of the electronic card key, comprising the administration code of the electronic card key 100 to be used by the key administration system, access allowed door codes, information on the key user, input date/time, etc. (S634), whereupon the key administration system stores and administers the inputted key use information as classified by the key administration codes (5635).

FIG. 14 is a detail flowchart for the step of transmitting the reference information to an electronic card key (S650) as illustrated in FIG. 10. Here, the administrator can be authenticated by inputting his fingerprint after having accessed the electronic card key administration system (S651, S652). Since the administrator authentication process by the key administration system is the same as in FIGS. 12 to 13, an explanation thereof is omitted here. After the administrator authentication, the administrator connects the electronic card key 100 to be used to the key administration system through the data transceiver part of the administration system (S654). The key administration system recognizes then the accessed key administration code and displays the list of the electronic card key use information (key administration codes, access allowed door codes, user information, input date/time, etc.) stored under the corresponding key administration code (S655), whereupon the administrator selects the item of the use information to be transmitted to the electronic card key, and then, pushes the transmit button (S656). The electronic card key administration system produces a data frame comprising fingerprint code of the registered administrator, transmission date/time, an initialization completion code set to “1” in addition to the electronic card key use information and transmits the same to the electronic card key 100 (S657, S658).

Here, the administrator fingerprint codes, access allowed door codes, transmission date/time (or date/time of use information input), and initialization completion code should necessarily be included in the reference information data frame, while the other information such as key administration code, user information, etc. may optionally be included. The reason why the key administration code needs not be included obligatory is that this code is included in the electronic card key 100 and the key administration system has already confirmed this fact.

Although the step of inputting the electronic card key use information by the administrator and the step of reference information transmission have been explained as separate steps in the above embodiment, the two steps can also be combined to one, i.e. if the administrator requests a transmission concurrently with his input of the electronic card key use information, the key administration system produces the reference information data frame in real time and transmits the same to the electronic card key.

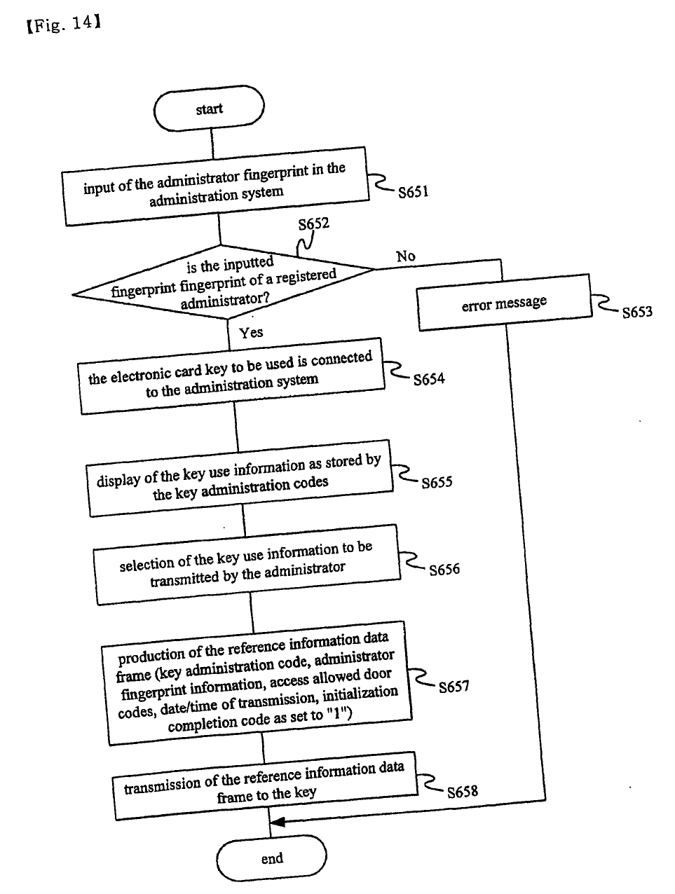

FIG. 15 is a detail flowchart for the step of updating the reference information of the electronic card key based on the reference information data frame received by the electronic card key 100.

The electronic card key 100, after having received the reference information data frame from the key administration system, searches the key administration codes in the electronic card key 100 and checks whether any key administration code coincides with the key administration code of the received data frame (S671, S672, S673). After confirming the key administration code, it is checked whether the initialization completion code of the data frame is set to “1” (S674). Since all authentic reference information data frame received shall have an initialization completion code set to “1” an error message is released to all data frames having an initialization completion code set to “0”, whereupon the operation is terminated (S675).

If the initialization completion code is set to “1”, the card key is initialized by erasing all information relating to the previous user stored in the electronic card key 100, i.e. reference information (key administration codes, administrator fingerprint codes, date/time of registration, access allowed door codes, initialization completion code), user fingerprint information, and access information (S676), and then, the reference information of the newly received data frame is stored in the corresponding area of the card key (S677). Although it is desirable for protection of the personal information that the information on the previous user is deleted, it is also possible that the information deleted from the electronic card key 100 is transmitted to the electronic card key administration system and stored separately for the purpose of customer services in the future.

After this procedure, the electronic card key 100 is distributed to a user and the user registers as an authorized user by inputting his fingerprint. Since the subsequent steps of user authentication and information transmission to the door lock device 310 (S700) and of locking/unlocking of the door (S710) are the same as in S550 and S570 in FIG. 5, an explanation therefore is omitted.

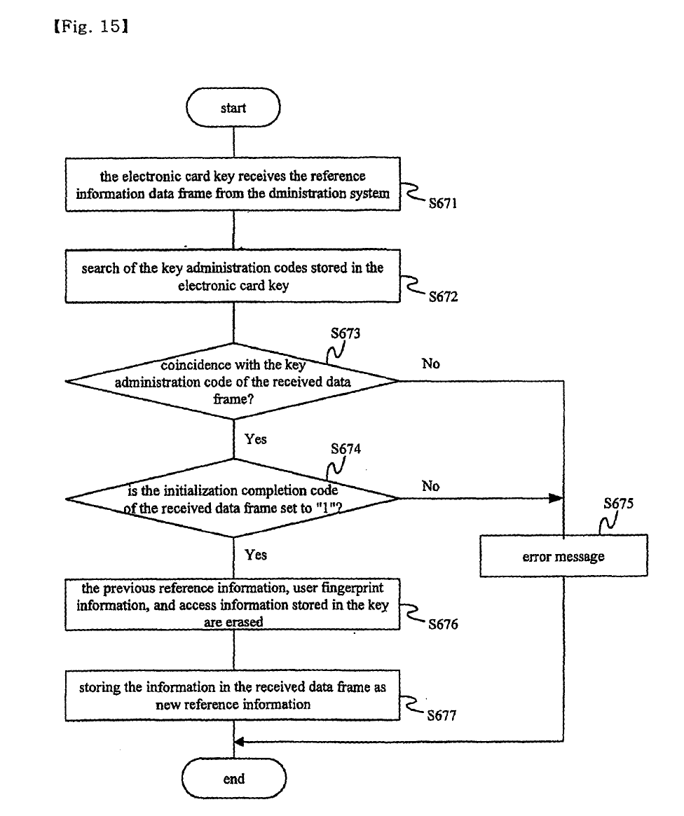

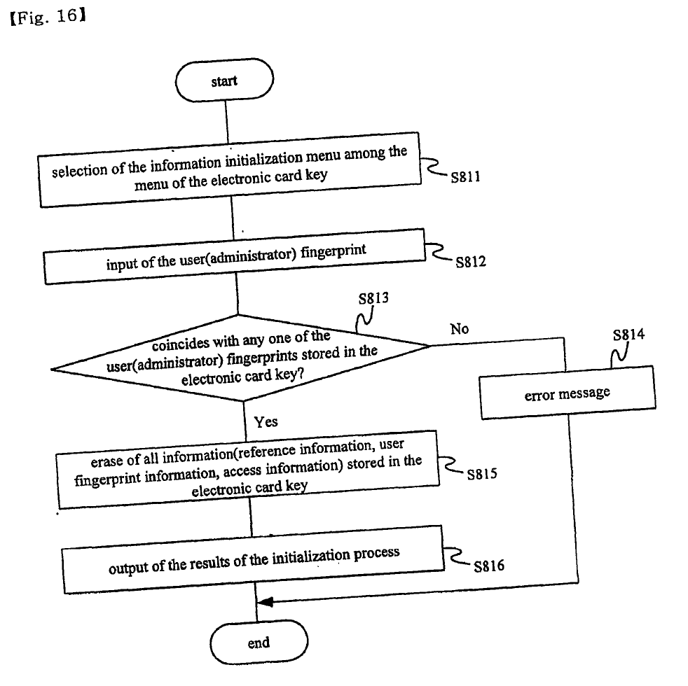

The erasing (initialization) of the information on the previous user can be effected by transmission to an electronic card key 100 of a new data frame having an initialization completion code set to “1”, as described above. However, this can additionally be effected by a direct order of the user or the administrator to the electronic card key 100. FIG. 16 illustrates the step of erasing internal information of the electronic card key 100 by an administrator or a user. The user or administrator wishing to erase internal information selects the internal information erase (initialization) menu in the menu of the electronic card key 100 (S813). Upon input of the fingerprint by the user or administrator (S812), the electronic card key 100 checks whether the inputted fingerprint coincides with any one of the registered user or administrator (S813). If the user or administrator is authenticated, the electronic card key 100 erases all relevant information stored in it, i.e. the reference information (key administration codes, administrator fingerprint codes, access allowed door codes, date/time of registration, initialization completion code), user fingerprint codes, access information, and displays the results to the user or administrator (S815, S816).

Furthermore, though not illustrated here, the electronic card key administration system as a central host and the door lock devices 310 can also be networked electrically. This embodiment has the advantage that the information stored in the door such as access information, etc. can be transmitted to the electronic card key administration system, and then, stored and administrated there. Accordingly, even when a user deletes access information of the electronic card key 100 without consent of the administrator, the access information of a door lock device 310 can be transmitted to and stored in the electronic card key administration system so that an integrated administration of the data is enabled.

Now, an explanation of the method for door lock system using an electronic card key 100 in accordance with the present invention as described in FIGS. 1 and 2a, and using an electronic card key administration system as described in FIG. 4a; and the method for user identification by that system is given below.

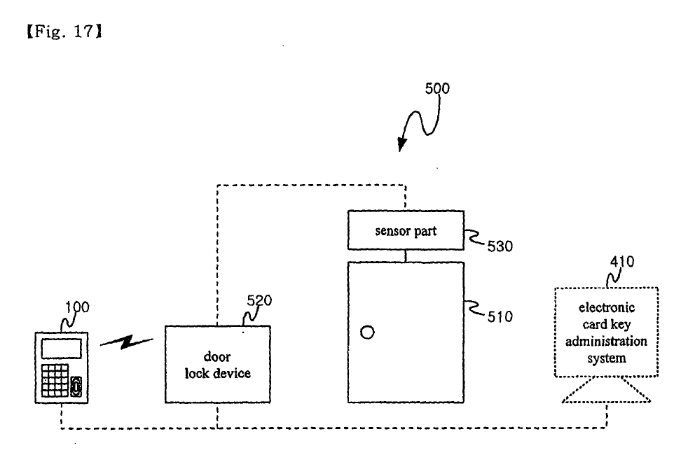

FIG. 17 illustrates the construction of a door lock system using an electronic fingerprint recognition card key 100 in accordance with another embodiment of the present invention, wherein an electronic fingerprint recognition card key 100 as in FIGS. 1 and 2a, and an electronic card key administration system 410 as in FIG. 4a are used.

As illustrated in FIG. 17, the door lock device of the present invention is consisted of an electronic fingerprint recognition card 100 which is used as the key, a door lock device 520 which is installed at the door 510, and a sensor 530.

Here, an electronic card key administration system 410 can be used as a central host for general administration of locking/unlocking of the door by the door lock system and of the user confirmation, wherein the electronic card key administration system 410 administers locking/unlocking of the door as well as the user authentication as described in FIGS. 4a and 4b.

If an authorized user having an electronic card key 100 opens a door by transmitting the data frame stored in the electronic card key 100 to the door lock device 520, the sensor part 530 counts the subsequent one or more user and the door lock device 520 requests the electronic card key(s) of the user(s) 100 to transmit the data frarne(s).

The door lock device 520 checks whether any user having an electronic card key 100 with no authorization or having no electronic card key 100 exists based on the data frame transmitted from the electronic card key 100 and the counting results of the sensor part 530, releases an error message if necessary, and stores the access information.

As such, the electronic fingerprint recognition card key 100 used in the door lock system in accordance of another embodiment of the present invention has a construction and function as described in FIG. 2a, the controller 210 of the electronic fingerprint recognition card key 100 has additional function as stated below in the door lock system 500.

The basic functions of the controller 210 in the door lock device 500 are to store the reference information after receipt thereof from the electronic card key administration system 410 or the administrator, to register user fingerprint codes, and to transmit data frame to the door lock system 500 after authentication of a user. Further, the controller 210 shall additionally function to transmit the stored reference information data frame within a predetermined time limit upon request of the door lock system 500 for data frame transmission, in order to practice the door locking/unlocking and the method of user authentication in accordance with the present invention.

On the other hand, the electronic card key administration system 410, which is for general administration of the door locking/unlocking and the method of user authentication in the door lock system, includes one or more administrator fingerprint codes; stores one or more of key administration codes inputted by authenticated administrator using administrator fingerprint codes, user information code of the electronic card key, and date/time of the information input; transmits the reference information data frame comprising the above key administration code, one or more access allowed door codes, one or more administrator fingerprint codes, present time information code, and electronic card key initialization completion code in as per the order of the administrator authenticated by the administrator fingerprint, so that the information is used for administration of the electronic card key 100. In addition, it is preferable that the electronic card key administration system 410 is capable of exchanging data with all of the above door lock devices 520 and/or with the above electronic card keys 100, for general storage and administration of the access information.

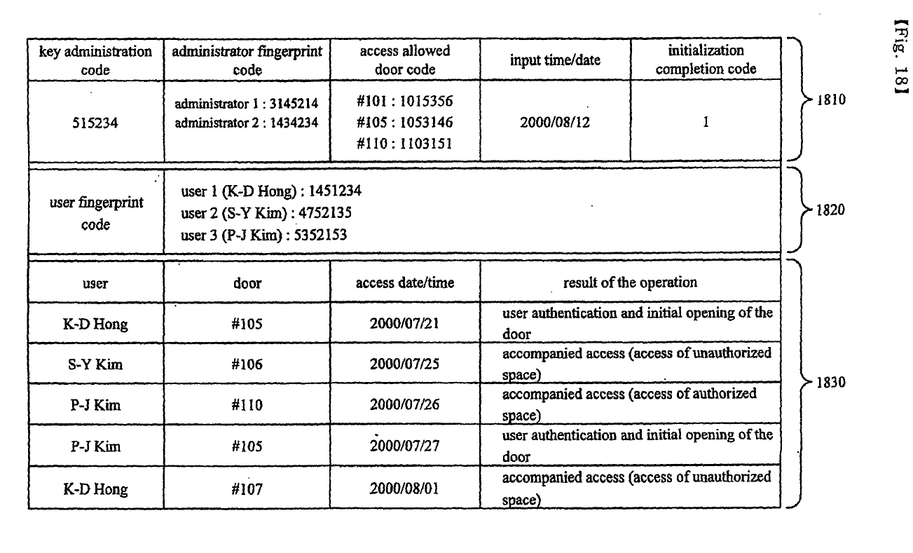

FIG. 18 shows the data structure used as the door lock information in the door lock system in FIG. 17 in the form of a table, which data structure is stored in the data storage part 216 of the fingerprint recognition card key 100 in the door lock system 500.

As shown in FIG. 18, the data storage part 216 of the fingerprint recognition card key 100 in the door lock system 500 comprises reference information 1810, user fingerprints information 1820, and access information 1830,

While the reference information 1810 and user fingerprints information 1820 are consisted of the same information as in FIG. 2b, the access information 1830 is consisted of the following information:

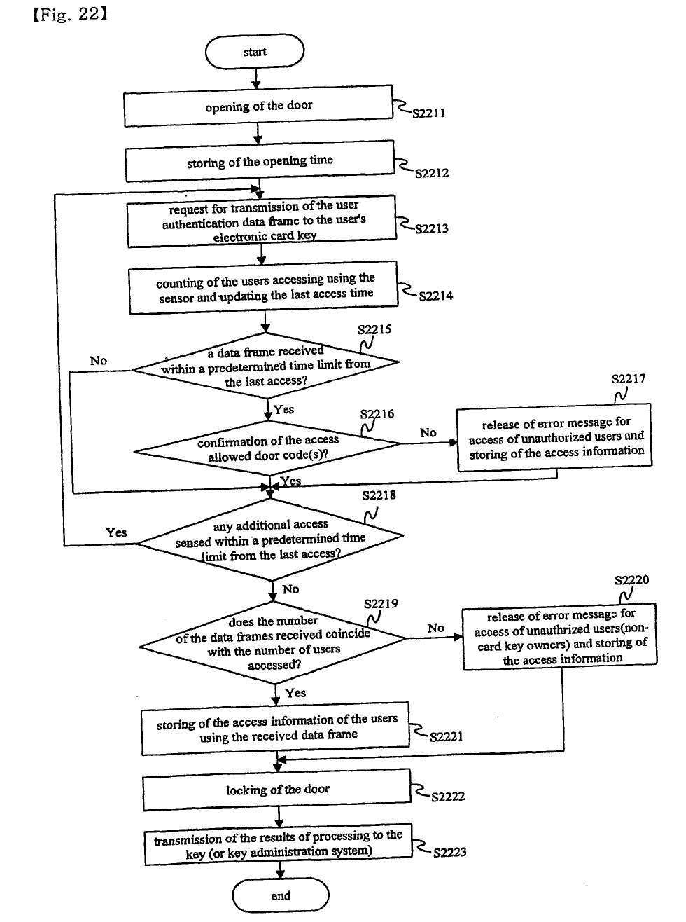

The access information 1830 in the door lock system 500 may comprise user information, date/time of access, access door codes, and results of the operation. The results of operation may be classified to one of the items: “user authenticated and the door initially opened” for the cases when a user of an electronic card key 100 has first opened an allowed door; “accompanied access (unauthorized access) for the cases when an owner of an electronic card key 100 has entered/exited a space not allowed to him in accompany of an authorized person; and “accompanied access (authorized access) for the cases when a user of an electronic card key 100 has entered/exited a space allowed to him in accompany of an authorized person, etc. The situations under which the above items occur are explained below making reference to FIG. 22. The above results of operation can be displayed upon request of the user.

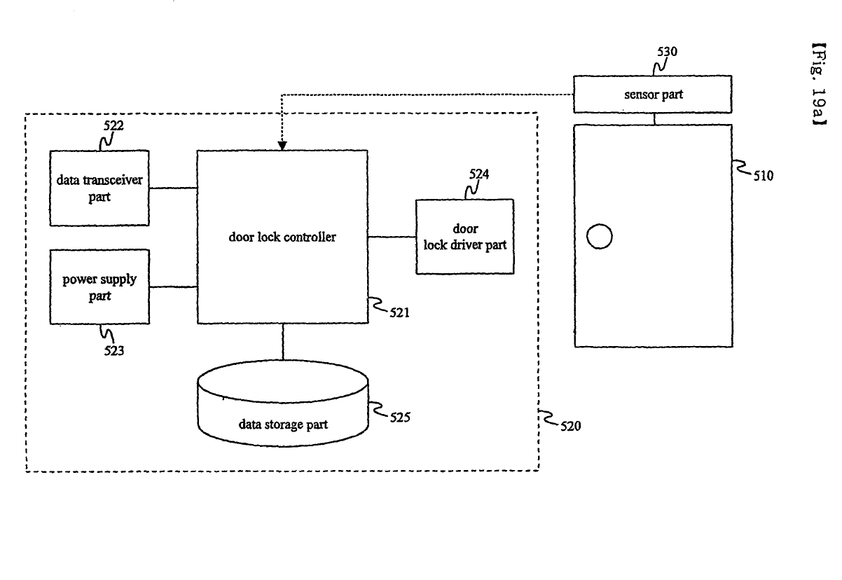

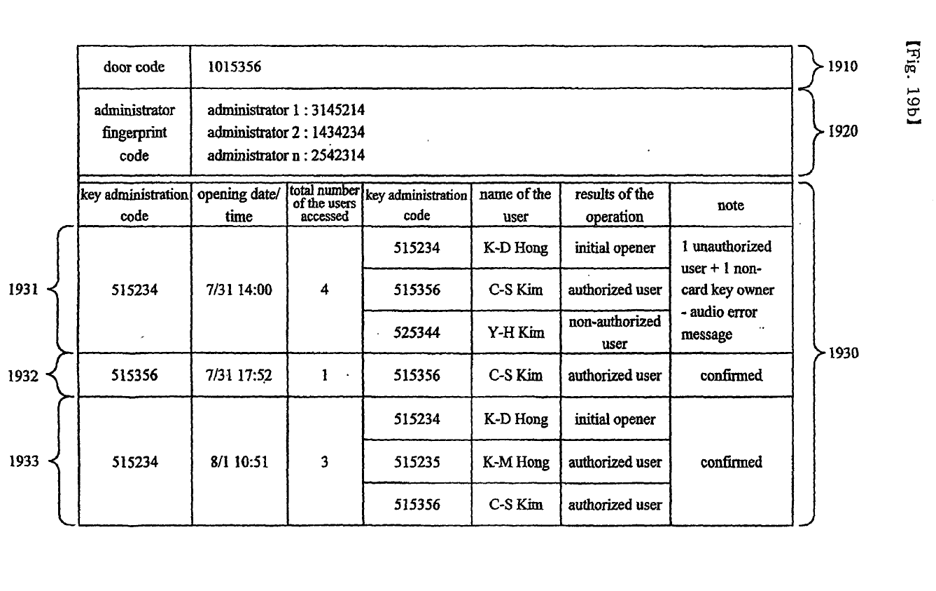

FIG. 19a is a detail block diagram for the door lock device of the door lock system in FIG. 17.

As shown in FIG. 19a, the door lock device 520 in the door lock system 500 comprises a door lock controller 521, a data transceiver part 522 for exchange of data with the electronic card key 100, a power supply part 523, a door lock driver 524 which locks/unlocks the door based on the control signal from the door lock controller 521, and a data storage part 525. The sensor part 530 which is consisted of one or more sensors fixed at the door or adjacent thereto, counts the number of the persons access the door based on the sensed signals and then transmits by wire or wireless the results of the counting to the door lock controller 521. Alternatively, the sensed signal as such can be transmitted to the door lock controller 521, instead of the counted number of the persons.

The door lock controller 521 which determines whether or not to lock/unlock the door by comparing the information received from the electronic card key 100 with a part of the data (the door codes and the administrator fingerprint codes) stored in the data storage part 525, and confirms authorizations to access the door after having identified and counted the users, comprises a counter (or a clock), an interrupter, any one of 8 bit microprocessor of 8051 cores or more, or 16 bit microprocessor of 68000 cores or more having a serial or parallel port, etc., and a ROM, such as EPROM which stores the program for basic operation of the processor.

The data transceiver part 522, which is used for exchange of data with the electronic card key 100, may be constructed as a conventional contact-type magnetic card reader, but is preferably made as a contactless RF transceiver for convenience of the users. However, for the signal transmission between the sensor part and the controller, other means including wired communication such as RS-232C may be used.

The data storage part, which may be composed of a small capacity (several k-bytes) flash memory, RAM, etc., stores the entrance/exit information 1930 including its own door code (1910), fingerprint codes of the registered administrators (1920), dates/time of locking/unlocking as classified by the key administration code which has initially opened the door, the total number of entered/exited persons, key administration codes of each entered/exited user, names of the entered/exited users, the results of operation, remarks, etc. The access information under reference number 1931 shows that the door was initially opened by a user, “K. D. Hong” using an electronic card key with the administration code no. 515234, and that a total of four person have passed the door while it was open, with the confirmation that the four persons consisted of the initial opener, “K. D. Hong”, an authorized card key owner, “C. S. Kim”, an unauthorized card key owner, “Y. H. Kim”, and an unknown card key non-owner. An additional information that an audio error message has been released alerting the entrance of the two unauthorized persons (“Y. H. Kim” and the unknown person), is given under the column, “Remarks”. The total number of access persons is sensed by the sensor part while the authentication of a card key owner is made based on the data frame exchange between the card key and the door lock device, an explanation thereof follows in reference to FIG. 6 later.

For protection of the personal information, the access information stored in the data storage part 525 shall be deleted every time when the user is changed (i.e. when the initialization completion code changes from “0” to “1”) even if the key administration code remains the same. However, since it is desirable that access information is administrated by the administrator and/or the key administration system 410, it is preferable that the access information is transmitted to the linked key administration system and stored there prior to its erase. Among the data stored in the data storage part 525, the door code 1919 is given initially, while the administrator fingerprint information 1920 and the access information 1930 shall be inputted or deleted by the electronic card key 100 any time.

The door lock driver 524 which locks/unlocks the door in accordance with the lock/unlock signal from the door lock controller 521, may be composed of one or more relay driver unit(s) and solenoid driver unit(s), but is not limited thereto.

Moreover, the door lock device 520 may additionally include a display part using e.g. LCD for displaying the results of operation, an audio output unit for releasing audio error message comprising speakers and ARS, etc. Further, the access allowed door code(s), to be stored in EPROM, etc. of the door lock device, is generally set initially at the time of production, but may also be set by the administrator using, e.g. a dip switch.

The sensor part 530, to be composed of one or more contactless infrared sensors, ultrasonic sensors, weight sensors, or optical sensors installed on any part of the frame of the door 510, can be so designed that its output (voltage or current) is directly inputted in the door lock controller 521, or as a sensor module capable of independently functioning to confirm and count the number of the persons based on the signals of the sensor. The sensor can be one or more light block type sensors to be installed two or more dimensionally, or one or more contactless infrared sensors such as thermopile, but is not limited thereto, insofar as it can sense the number of the users, like a CCD camera. However, since the sensor must also sense a continuous entering of the users, it is preferable that the response time of the sensor is very short, i.e. it should not exceed several milliseconds.

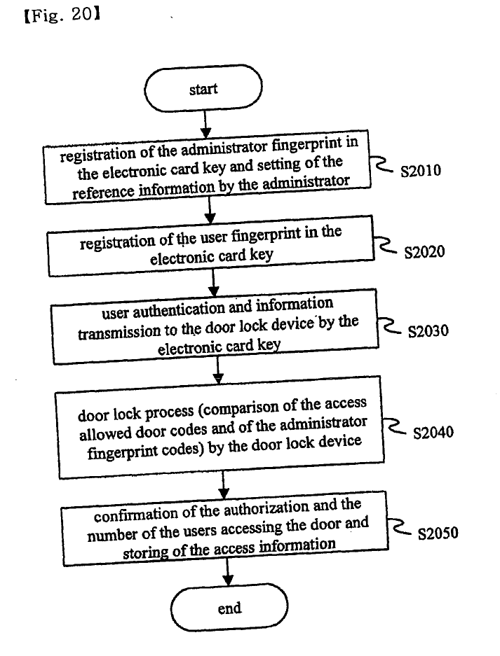

FIG. 20 is a flowchart showing the first door lock method and user confirmation method of the door lock system in accordance with another embodiment of the present invention.

As shown in FIG. 20, the first door lock method and user confirmation method comprise basically the steps of registering the administrator fingerprint at the electronic card key 100 by the administrator and fixing the reference information (S2010); of registering the user fingerprint at the electronic card key 100 (S2020); authenticating the user and transmitting this information to the door lock device 520 by the electronic card key 100 (S2030); locking/unlocking of the door by the door lock device 520 (S2040); and confirming the authorization of the users as well as the number of the users who have passed the door after the door has been opened, and storing the access information (S2050). The basic principle of operation of this method is: When a user has registered his fingerprint in an electronic card key authenticated by an administrator, upon input of the user's fingerprint, the corresponding information (data frame for unlocking the door) stored in the electronic card key 100 is transmitted to the door lock device 520, so that the information transmitted from the electronic card key 100 (access allowed door codes and administrator fingerprint codes) is compared with the information stored in the door lock device 520, on the basis of which comparison a decision for locking/unlocking of the door is made, and in case the door 510 has been opened, the total number of persons passing the door is counted by the sensor 530 and authorizations of the accompanying persons are checked by data exchange with the electronic card key 100.

The present invention, being an invention concentrating in the user authentication and administration after opening of the door, may use the above described methods for the steps up to the opening of the door, i.e. for the steps of administrator fingerprint registration and setting the reference information (S2010), of user fingerprint registration (S2020), of information transmission to the door lock device (S2030), and of door locking/unlocking (S2040).

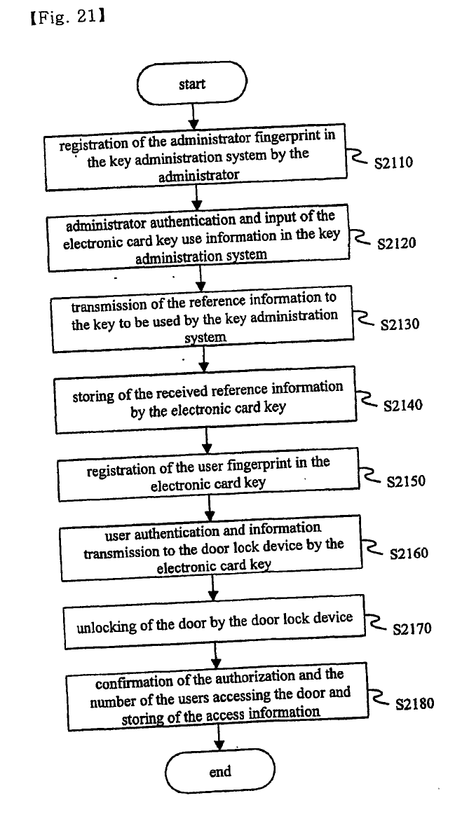

FIG. 21 is a flowchart showing the second door lock method and user confirmation method of the door lock system in accordance with another embodiment of the present invention.

As shown in FIG. 21, the second door lock method and user confirmation method comprise basically the steps of administrator fingerprint registration in the electronic card key system 410 (S2110), of administrator authentication and inputting the use information of the electronic card key 100 by the electronic card key administration system 410 (S2120), of reference information transmission to the electronic card key 100 from the electronic card key administration system 410 (S2130), of storing the received reference information by the electronic card key 100 (S2140), of registering the user's fingerprint in the electronic card key 100 (S2150), of user authentication and information transmission to the door lock device 520 by the electronic card key 100 (S2160), of locking/unlocking of the door by the door lock device 520 (S2170), and of confirming the authentications as well as the number of persons passing the door and storing the access information (S2180).

Although basically similar to the first door lock method described in FIG. 20, the second door lock method and user confirmation method differs from the first in that the electronic card key administration system 410 as the central host is responsible for the administrator fingerprint registration and transmission of the reference information to the electronic card key 100, while in the first method the administrator directly inputs these information to the card key. However, the steps of user authentication, confirmation of the number of persons passing the door after opening thereof, and access information storing (S2180), which constitute the essence of the present embodiment, are the same as those in the above first method. In addition, the steps up to the opening of the door are also the same as those in the above first method.

FIG. 22 is a detail flowchart showing the steps of user authentication as well as confirming the number of the persons passing the door, and storing the access information after opening of the door in accordance with the above first and second methods as described in FIGS. 20 and 21, respectively.

As shown in FIG. 22, when the door is duly opened (S2211) after the steps of user authentication and of locking/unlocking of the door, the door lock device 520 stores the initial opening time of the door (S2212). Then, the door lock device 520 requests one or more electronic card keys 100 of the users including the user who initially opened the door to transmit the data frame for authentication (key administration codes, administrator fingerprint codes, access allowed door codes, initialization completion code, etc.) (S2213). Such request for data frame can be received also by electronic card keys 100 which are relatively distant from the door lock device 520, because the request is transmitted to the data transceiver part 214 of the electronic card key 100 from the data transceiver part 522 of the door lock device 520. Simultaneously with the request for transmission of the data frame, the number of the persons passing the door is counted by the sensor 530 and the last access time is updated (S2214).

If the data frame has been received from the electronic card key 100 within a predetermined time limit after the last access time, an owner of the electronic card key 100 is authenticated by confirming whether any access allowed door code of the data frame coincides with the its door codes (S2215, S2216). In case the sensor part senses additional passage within a predetermined time limit after the last access time (S2218), the electronic card key 100 of this user is requested to transmit the data frame, the number of the persons passing the door is counted, and the last access time is updated (S2213, S2214). In case the user is a non-owner of the electronic card key 100, no data frame is received within a predetermined time limit, and the next step of confirming additional person passing the door begins (S2218), after the above user is recorded as unidentified person who has passed the door without authorization.

In case no additional access has been sensed within a predetermined time limit, it is determined that all users have entered/exited, and the numbers of the data frame received finally as well as of the persons entered/exited are confirmed (S2219). If these numbers do not coincide with each other, the difference is recognized as the number of non-owner of the electronic card key 100 with no authorization to access, so that an error message is released and the access information is stored (S2220, S2221). The error message can be released after completion of all passages, or it can also be released for each unauthorized passage. If authentication of each user in real time is not easy, the data frames received from the electronic card keys 100 upon request therefor can be stored until all the users have passed the door, and then, an error message can be released after the data frames and the number of the passages have been processed.

The final results of the processing can be stored as access information as in FIG. 3b, or, if necessary, in the electronic card key 100 as in FIG. 2b. The access information (process results) thus stored can subsequently be transmitted to the linked electronic card key administration system 410 to be stored and administered there, or can be checked directly by the administrator.

Here, not only identification of persons passing the door without authorization based on the stored and administered access information (in case the corresponding persons own the electronic card key 100), but also confirming of the persons with no electronic card key just accompanying the user who has initially opened the door, are possible by asking the user. Accordingly, an integrated administration of the access information as well as maintenance of access security are enabled so that theft, etc. can be prevented.

Although not illustrated, a step of confirming the administrator fingerprint code can also be added to the step of confirming the access allowed door codes of the data frame received from the electronic card key 100 during a user authentication such as for the initial opening of a door.

After the access information (the results of the operation) is stored (S2221), the door lock device 520 locks the door 510 (S2222) and transmits the results to the corresponding electronic card key 100 and/or electronic card key administration system 410, for storage and administration there (S2223).

### Industrial Applicability

As explained above, the present invention resolves the problems related to the conventional lock/unlock devices utilizing metallic keys or passwords, such as loosing of the key or leakage of the passwords, by using fingerprint information as a key.

On the other hand, the present invention introduces an electronic card key capable of recognizing fingerprints in order to overcome the following disadvantages of the conventional fingerprint recognition lock/unlock devices using the users' fingerprints as keys: i) The fingerprint input part to be installed at the door lock device can easily be damaged due to its external exposure; ii) Since the fingerprint information stored in the door lock device needs to be updated by the administrator for each change of the allowed user, it is not practical in use for doors with frequent change of users; iii) Since the access information stored in the door lock device is available to the administrator at any time, the personal information stored is not sufficiently protected; and so further.

In the present invention, the administrator fingerprint is first registered in order to secure that only the administrator has the right to update the information in the fingerprint recognition card (access allowed door codes), and then, fingerprint of a user is registered in an electronic card key duly distributed by the administrator. If a user has been authenticated after inputting his fingerprint for each access of the door, the electronic card key transmits the corresponding information stored in it to the door lock device, whereupon the door lock device locks/unlocks the door only when the access allowed door code and the administrator fingerprint information transmitted from the electronic card key correspond with the corresponding door code and the administrator fingerprint code, respectively, stored in it. The access information is automatically deleted if a new user of the electronic card key is registered.

The access thus controlled, the disadvantage with the conventional lock/unlock device described above under ii) can be removed, since an administrator of a lodging institution with frequent change of the users does not require to access each door and update information, but rather simply to distribute electronic card keys containing the basic information.

Further, since a fingerprint input part is installed in the electronic card key only, not at the door lock device to be exposed externally, according to the present invention, the disadvantage mentioned above under i) is also removed.

In addition, since the access information and the user information stored in the electronic card key and the door lock device are automatically erased by each change of the user according to the present invention, leakage of personal information can be prevented, and thus, the disadvantage mentioned above under iii) is removed.

To summarize, the electronic fingerprint recognition card key, external door lock device and/or the door lock method and method for confirming persons passing the door using the electronic card key administration system in accordance with the present invention enables to fundamentally resolve the problem of loosing the key or leakage of the passwords related with the conventional lock/unlock devices which use metallic keys or passwords, by utilizing fingerprints as keys; is not likely to be damaged in contrast to the conventional fingerprint recognition lock/unlock devices where the fingerprint input part is exposed externally; enables easy administration of the keys even for doors with frequent change of the users; and can effectively prevent leakage of personal information.

In addition to these advantages, the present invention enables better administration of the user and maintenance of security for each door by confirming the number of persons having passed the door after initial opening of the door and confirming of the authentication of one or more users passing the door, which functions were not provided by the conventional access control method using electronic card keys.

What is claimed is:

1. An electronic fingerprint recognition card key comprising:
an input part which allows a user to select functions;
a data transceiver part for exchange of data with an external door lock device;
a data storage part which stores a key administration code which is the unique code for the electronic card key, administrator codes which correspond to one or more administrators of the electronic card key, one or more access allowed door codes representing the access allowed doors, and user fingerprint codes corresponding to one or more users who are allowed to access; and
a controller part which transmits the administrator codes and the access allowed door codes stored in said data storage part through said data transceiver part, if the user fingerprint recognized by said fingerprint part coincides with one of the user fingerprint codes stored in said data storage part.

2. The electronic fingerprint recognition card key as set forth in claim 1, wherein said data transceiver part is consisted of a contact-type I/O terminal and a RF transceiver part to enable RF communication with the external door lock device.

3. The electronic fingerprint recognition card key as set forth in claim 1, wherein said controller sends a transmission request to the external door lock device informing that data will be transmitted, in case the fingerprint inputted to the fingerprint recognition part coincides with any one of the user fingerprint codes, and then transmits the administrator codes and the access allowed door codes stored in said data storage part to the external door lock device, if a receive-ready signal allowing transmission of data has been received within a predetermined time after the transmission request from the external door lock device.

4. The electronic fingerprint recognition card key as set forth in claim 1, wherein said administrator code is an information code which corresponds to the fingerprint of the administrator.

5. The electronic fingerprint recognition card key as set forth in claim 1, wherein said data storage part comprises additionally an initialization completion code which indicates whether or not the electronic card key is initialized, an input time information code containing the date/time of inputting said codes by the administrator, and access information of each access including locking/unlocking date/time of the door, information on the user who has locked/unlocked the door; and
said controller part transmits said initialization completion code along with said administrator codes and access allowed door codes stored in said data storage part to the external door lock device through said data transceiver part, in case the user fingerprint inputted to said fingerprint recognition part coincides with any one of the user fingerprint codes stored in said data storage part.

6. A door lock device comprising:
a data storage part which stores a door code representing the door equipped with the door lock device, and one or more administrator codes representing the administrator(s) authorized to lock/unlock the door;
a data transceiver part for exchange of the data;
a door lock driver which locks/unlocks the door; and
a door lock controller which controls said door lock driver to lock /unlock the door, if any of door codes and any of administrator codes received from said data transceiver part coincide with the door code and any of the administrator codes, respectively, stored in said data storage part.

7. The door lock device as set forth in claim 6, wherein said door lock controller sends a door lock signal to the door lock driver, if the door code stored in said data storage part coincides with any one of one or more door codes received from said data transceiver part, and one or more administrator codes stored in said data storage part coincide with any one of one or more administrator fingerprint codes received from said data transceiver part.

8. An electronic card key administration system comprising:
a computer part including a CPU, a data storage part, a display part, and a data input part; and
a fingerprint input device consisting of either a built-in fingerprint input device having a data transceiver part for exchange of data with the electronic card key as per claim 1 and a fingerprint input part, to be installed inside of said computer part, or an external fingerprint input device having a data transceiver part for exchange of data with an electronic card key or with said computer part and a fingerprint input part, to be installed external to said computer part;
wherein said computer part, comprising one or more administrator fingerprint codes, stores in said storage means at least one of the following codes: a key administration code inputted by an authorized administrator using the administrator fingerprint code, one or more access allowed door codes, the user information codes of the electronic card keys, and the date/time information code of the information input; and
wherein a reference information data frame consisting of said key administration code, one or more access allowed door codes, one or more administrator fingerprint codes, the present date/time information code, and the initialization completion code of the electronic card key, is transmitted to the electronic card key to be used upon order of the administrator authenticated by the administrator fingerprint code.

9. The electronic card key administration system as set forth in claim 8, wherein the data transceiver part of said fingerprint input device is consisted of a contact-type I/O terminal and a RF transceiver part to enable RF communication with the electronic card key.

10. A door access control method using electronic fingerprint recognition card key as set forth in claim 1 and door lock device as set forth in claim 6, comprising the steps of:
inputting one or more administrator codes and one or more access allowed door codes in the electronic card key;
registering a user fingerprint code by inputting his fingerprint in the electronic card key;
transmitting said one or more administrator codes and said one or more access allowed door codes to the door lock device after the user has been authenticated by inputting his fingerprint in the electronic card key, if access of the door is sought; and
unlocking the door, if and only if any one of said one or more access allowed door codes received by the door lock device from the electronic card key coincides with the door code stored in the door lock device, and any one of said one or more administrator codes received coincides with one or more administrator codes stored in the door lock device.

11. The door access control method as set forth in claim 10, wherein said electronic card key and the door lock device stores accumulatively the access information of each access, comprising the key administration code, access times for each key administration code, and the date/time of access.

12. The door access control method as set forth in claim 10, wherein
said administrator code is the fingerprint code of the administrator; and
said step of inputting codes in the electronic card key further comprises the steps of:
inputting the administrator fingerprint in the electronic card key;
registering the inputted administrator fingerprint code as the administrator fingerprint if no administrator fingerprint has been registered, or checking whether said inputted administrator fingerprint coincides with any one of the registered administrator fingerprints if any administrator fingerprint code has been registered;
requesting input of any of the registered administrator fingerprints if said inputted fingerprint does not coincide with any one of the administrator fingerprints registered, and registering said inputted fingerprint as a fingerprint code of a new administrator if fingerprint of the corresponding registered administrator is inputted; and
storing the door codes for doors accessible by the electronic card key as inputted by the administrator, if a new administrator fingerprint code is registered, or if said inputted fingerprint coincides with the registered administrator fingerprint, and setting the initialization completion code to “1”.

13. The door access control method as set forth in claim 10, wherein said step of registering user fingerprint code additionally comprises the steps of:
inputting fingerprint of the registered user when the user fingerprint has already been registered;
inputting fingerprint of a user whishing to be added; and
registering additionally of said additional user's fingerprint as the users' fingerprint codes.

14. The door access control method as set forth in claim 13,
wherein said step of inputting administrator codes additionally includes the step of setting the initialization completion code of said electronic card key to indicate that the electronic card key has been initialized; and
wherein said step of user fingerprint registration additionally comprises the step of releasing an error message if said initialization completion code of said electronic card key indicates that it is not initialized.

15. The door access control method as set forth in claim 14,
wherein said step of transmitting codes comprises the steps of:
inputting the user fingerprint by the user as the user selects the door lock function;
checking whether the inputted fingerprint coincides with any one of the registered user fingerprints;
sending a transmission request notifying transmission of data to the door lock device by the electronic card key in case of coincidence, and checking whether a receive-ready signal which means allowance to transmit is received from the door lock device within a predetermined time limit;
transmitting a data frame including the administrator codes and the access allowed door codes stored in the electronic card key to the door lock device upon receipt of a receive-ready signal from the door lock device within a predetermined time limit;
receiving the results of the operation by the electronic card key from the door lock device within a predetermined time limit after transmission of the data frame, and then resetting the initialization completion code in case of initial opening of the door, and displaying the results of the operation and the access information to the user.

16. The door access control method as set forth in claim 15,
wherein said data transmitted in said step of transmitting codes includes a unique administration code of the corresponding key; and
wherein said step of unlocking the door comprises the steps of:
checking by the door lock device whether any one of the access allowed door codes received from the electronic card key coincides with its door code, and releasing an error message in case of non-coincidence;
registering the administrator fingerprint code of the received data frame by the door lock device in case the door lock device is in initialized state with no administrator fingerprint stored in it; and checking by the door lock device whether any one of the administrator fingerprint codes received coincides with any one of the fingerprints of the registered administrators, and updating the received administrator fingerprint code as the fingerprint information of its administrator in case of coincidence, or of releasing an error message in case of non-coincidence;
checking whether the initialization completion code is set, and then initializing the access information corresponding to the received key administration code among the access information of the door lock device in case the initialization completion code has been set, and adding the access information as classified to the key administration codes in case the initialization completion code has not been set; and
unlocking the door by the door lock device, and then transmitting the results of the unlocking operation and the updated access information to the electronic card key.

17. A door access control method using electronic fingerprint recognition card key as set forth in claim 1, door lock device as set forth in claim 5, and electronic card key administration system as set forth in claim 7, comprising the steps of:
administrator fingerprint registration wherein one or more administrators input administrators' fingerprints in said electronic card key;
inputting the use information of the electronic card key wherein the administrator, after having been authenticated by inputting his fingerprint in the electronic card key administration system inputs at least one of the key administration code of the electronic card key to be used, access allowed door codes, user information of the key, and date/time of information input;
transmitting the reference information wherein said administrator, after having been authenticated by inputting his fingerprint in the electronic card key administration system, produces a reference information data frame consisting of the key administration code, administrator fingerprint codes, access allowed door codes, input date/time of the above information, and the initialization completion code as set to “1”, and then transmits the same to the electronic card key to be used;
checking by the electronic card key whether the key administration code of the reference information transmitted coincides with the unique key administration code of the electronic card key and whether the initialization completion code is set, and then, resetting and updating the reference information with the transmitted reference information if the key administration codes coincide with each other and the initialization completion code is set;
user fingerprint registration wherein the user registers a user fingerprint code by inputting his fingerprint in the electronic card key;
user authentication and information transmission wherein the electronic card key transmits the reference information data frame to the door lock device after the user has been authenticated by inputting his fingerprint in the electronic card key, if access of the door is sought; and
unlocking the door, if and only if any one of said one or more access allowed door codes received by the door lock device from the electronic card key coincides with the door code stored in the door lock device, and any one of said one or more administrator codes received coincides with one or more administrator codes stored in the door lock device.

18. The door access control method as set forth in claim 17, wherein said electronic card key and door lock device store the access information comprising the key administration codes, access times as classified for the key administration codes, date/time of the access accumulatively for each access, and wherein the access information stored is also reset when the reference information is reset.

19. The door access control method as set forth in claim 17, wherein said step of administrator registration comprises the steps of:
inputting by the administrator of his fingerprint in the fingerprint input part of the electronic card key administration system;
registering the inputted administrator fingerprint code by the electronic card key as the administrator fingerprint if no administrator fingerprint has been registered, and checking whether said inputted administrator fingerprint coincides with any one of the registered administrator fingerprints if any administrator fingerprint code has been registered; and
requesting input of the administrator fingerprint if said inputted fingerprint does not coincide with any one of the administrator fingerprints registered, and then registering said inputted fingerprint as a fingerprint code of a new administrator if the fingerprint of the corresponding registered administrator is inputted.

20. The door access control method as set forth in claim 17, wherein said step of user fingerprint registration comprises additionally the steps of:
registering the fingerprint of an initial user desiring to use an electronic card key as the initial user fingerprint code; and
confirming by the registered user through input of the fingerprint of the registered user for registration of a new user fingerprint.

21. The door access control method as set forth in claim 20, which, in case no reference information is stored in the electronic card key, proceeds, after having released an error message, through the steps of:
administrator fingerprint registration;
inputting electronic card key use information;
transmitting the reference information; and
storing the reference information as set forth in claim 17;

22. The door access control method as set forth in claim 17, wherein said step of user authentication and information transmission comprises the steps of:
inputting the user fingerprint in the electronic card key;
checking whether the inputted user fingerprint coincides with any one of the registered user fingerprints;
sending a transmission request notifying transmission of data to the door lock device by the electronic card key in case of coincidence, and checking whether a receive-ready signal which means allowance to transmit is received from the door lock device within a predetermined time limit;
transmitting a data frame including the key administration code, the administrator fingerprint codes, the access allowed door codes, the initialization completion code stored in the electronic card key to the door lock device upon receipt of a receive-ready signal from the door lock device within a predetermined time limit;
receiving the results of the operation by the electronic card key from the door lock device within a predetermined time limit after transmission of the data frame, and then changing the initialization completion code from “1” to “0” in case of initial opening of the door, and displaying the results of the operation and the access information to the user.

23. The door access control method as set forth in claim 22, wherein a message notifying that the door cannot be opened is released, if no receive-ready signal, or no result of the locking/unlocking operation is received from said door lock device within a predetermined time limit.

24. The door access control method as set forth in claim 18, wherein said step of unlocking the door comprises the steps of:
checking by the door lock device whether any one of the access allowed door codes of the data frame transmitted from the electronic card key coincides with its own door code, and releasing an error message in case of non-coincidence;
registering the administrator fingerprint code of the transmitted data frame by the door lock device in case the door lock device is initialized with no administrator fingerprint stored in it; checking by the door lock device whether any one of the administrator fingerprint codes transmitted coincides with any one of the fingerprints of the registered administrators, and updating the received administrator fingerprint code as the fingerprint information of its administrator in case of coincidence, or releasing an error message in case of non-coincidence;
checking whether the initialization completion code is set to “1”, and then either initializing the access information corresponding to the received key administration code among the access information of the door lock device in case the initialization completion code is “1”, or adding the access information as classified to the key administration codes in case the initialization completion code is “0”; and
unlocking the door by the door lock device, and then transmitting the results of locking/unlocking operation and the updated access information to the electronic card key.

25. A door lock system for access control of a door using an electronic fingerprint recognition card key and data frame transmitted by said electronic card key, to be installed at doors for space where the access shall be controlled,
wherein said door lock system is consisted of door lock device(s) which include a door lock controller, a data storage part, a data transceiver part for exchange of data with the data transceiver part of the electronic card key, a door lock driver for locking/unlocking the door based on the control signal from the controller, and a power supply part; and one or more sensor parts which, installed on the frame of said door, sense the number of persons passing the door;
wherein said data storage part stores information consisting of the door code representing the door equipped with said door lock system and the administrator fingerprint code transmitted from the electronic card key, and access information including at least one of the administration code of the electronic card key which has locked/unlocked the door, access date/time information, the user who has entered/exited, total number of persons who have passed the door, authentication of the persons entered/exited.

26. The door lock system as set forth in claim 25, wherein said data transceiver part of said door lock device is consisted of a contact-type I/O terminal and a RF transceiver part to enable RF data exchange with said electronic card key.

27. The door lock system as set forth in claim 25, wherein said door lock controller sends a door unlock signal to said door lock driver if the door code stored in said data storage part coincides with any one of the access allowed door codes in the data frame transmitted from said electronic card key,
and then, sends a request for transmission of data frame to the electronic card key of one or more users passing the door after said door has been opened, receives the data frame, senses the number of the persons passing the door using said sensor part, confirms authentication of each user access the door, and stores said access information.

28. The door lock system as set forth in claim 27, wherein said door lock controller sends a door unlock signal if and only if one or more administrator fingerprint codes of the data frame transmitted from said electronic card key coincide with one or more administrator fingerprint codes stored in said data storage part, in addition to said coincidence of the door codes.

29. The door lock system as set forth in claim 27, wherein said door lock controller releases one or more of audio or text error messages for any unauthorized user passing the door.

30. The door lock system as set forth in claim 29, wherein said door lock system additionally comprises an audio output means including a speaker to enable releasing of audio error message.

31. A door lock method and user confirmation method using a door lock system as set forth in claim 25 and an electronic fingerprint recognition card key, comprising the steps of:
administrator registration and reference information setting, wherein fingerprint(s) of one or more administrator are inputted in said electronic fingerprint recognition card key, and then the electronic card key is distributed to the users after the authorized administrator has inputted one or more access allowed door codes in the electronic card key;
user fingerprint registration wherein said user registers a user fingerprint code by inputting his fingerprint in said electronic card key;
user authentication and information transmission wherein the electronic card key transmits a data frame consisting of the reference information to the door lock device after the user has been authenticated by inputting his fingerprint in said electronic card key, if access of the door is sought;
unlocking the door, wherein the door is unlocked, if and only if any one of said one or more access allowed door codes received by the door lock device from the electronic card key coincides with the door code stored in the door lock device, and any one of said one or more administrator codes received coincides with one or more administrator codes stored in the door lock device; and
checking the access authority and number of the users and storing access information, wherein a request for transmission of data frame is sent to the electronic card key of one or more users passing the door after said door has been opened, the data frame is received, the number of the persons passing the door is sensed using said sensor part, the authority of each user access the door is checked, and said access information is stored.

32. The door lock method and user confirmation method, as set forth in claim 31, wherein said step of checking access authority and number of the users and storing the access information comprise the steps of:
sending requests to transmit data frames by the door lock device to the electronic card key of one or more users passing the door after said door has been opened;
checking authority of corresponding users based on the data transmitted from the electronic card keys;
storing the access information and releasing an error message for access of an unauthorized user; and
locking the door in case no data frame is received from said electronic card key within a predetermined time limit.

33. The door lock method and user confirmation method, as set forth in claim 32, wherein said step of checking access authority and number of the users and storing the access information comprise the steps of:
checking the number of the users passing the door successively from the opening to the closing of the door using said sensor part;
locking the door if neither a data frame is received from the electronic card key(s), nor any additional passage of the door has been sensed by said sensor part, within respective predetermined time limits; and
storing the results of unauthorized access and releasing an error message in case the total number of the users who have passed the door as sensed by said sensor part differs from the number of the users who have transmitted data frames through said electronic card keys, after recognizing the difference as the number of unauthorized users.

34. The door lock method and user confirmation method, as set forth in any one of claims 32 or 33, wherein said step of checking authority of a user is performed by checking whether any one of the access allowed door codes in the data frame transmitted from said electronic card key coincides with the door code of the corresponding door.

35. The door lock method and user confirmation method, as set forth in claim 34, wherein said step of checking authority of a user is performed by checking whether any administrator fingerprint code in the data frame transmitted from said electronic card key coincides with any one of the administrator fingerprint codes stored in the data storage part of said door lock device, in addition to said coincidence of the door code.

36. The door lock method and user confirmation method, as set forth in claim 33, wherein said unauthorized user having passed the door is either an owner of the electronic card key having no authorization to access the door, or a non-owner of the electronic card key.

37. A door lock method and user confirmation method using an electronic card key administration system which is consisted of a computer device including a CPU, a data storage means, a display part, a data input part, a power supply part, and a built-in or stand-alone fingerprint input device consisted of a data transceiver part for exchange of data with the electronic card key and a fingerprint input part; the door lock device as set forth in claim 25; and the electronic card key(s), comprising the steps of:
administrator fingerprint registration wherein one or more administrators input administrators' fingerprints in said electronic card key;
inputting use information of the electronic card key wherein the administrator, after having been authenticated by inputting his fingerprint in the electronic card key administration system, inputs at least one of the key administration code of the electronic card key to be used, access allowed door codes, user information of the key, and date/time of information input;
transmitting the reference information wherein said administrator, after having been authenticated by inputting his fingerprint in the electronic card key administration system, produces a reference information data frame consisting of the key administration code, administrator fingerprint codes, access allowed door codes, input date/time of the above information, and the initialization completion code as set to “1”, and then transmits the same to the electronic card key to be used;
checking by the electronic card key whether the key administration code of the reference information transmitted coincides with the unique key administration code of the electronic card key and whether the initialization completion code is set, and then, resetting and updating the reference information with the received reference information if the key administration codes coincide with each other and the initialization completion code is set;
user fingerprint registration wherein the user registers user fingerprint code by inputting his fingerprint in the electronic card key;
user authentication and information transmission wherein the electronic card key transmits the reference information data frame to the door lock device after the user has been authenticated by inputting his fingerprint in the electronic card key, if access of the door is sought; and
unlocking the door, if and only if any one of said one or more access allowed door codes received by the door lock device from the electronic card key coincides with the door code stored in the door lock device, and any one of said one or more administrator codes received coincides with one or more administrator codes stored in the door lock device; and
checking access authority and number of the users and storing the access information, wherein a request for transmission of data frame is sent to the electronic card key of one or more users passing the door after said door has been opened, the data frame is received, the number of the persons passing the door is sensed using said sensor part, the authority of each user accessing the door is checked, and said access information is stored.

38. The door lock method and user confirmation method as set forth in claim 37, wherein said step of checking access authority and number of the users and storing the access information comprises the steps of:
sending requests to transmit data frames by the door lock device to the electronic card key of one or more users passing the door after said door has been opened;
checking access authorities of corresponding users based on the data transmitted from the electronic card keys;
storing the access information and releasing an error message for access of an unauthorized user; and
locking the door in case no data frame is received from said electronic card key within a predetermined time limit.

39. The door lock method and user confirmation method as set forth in claim 38, wherein said step of checking access authority and number of the users and storing of the access information comprises the steps of:
confirming the number of the users passing the door successively from the opening to the closing of the door using said sensor part;
locking the door if neither a data frame is received from the electronic card key(s), nor any additional passage of the door has been sensed by said sensor part, within respective predetermined time limits; and
storing the results of unauthorized access and releasing an error message in case the total number of the users who have passed the door as sensed by said sensor part differs from the number of the users who have transmitted data frames through said electronic card keys, after recognizing the difference as the number of unauthorized users.

40. The door lock method and user confirmation method as set forth in any one of claims 38 or 39, wherein said step of checking access authority of a user is performed by checking whether any one of the access allowed door codes in the data frame transmitted from said electronic card key coincides with the door code of the corresponding door.

41. The door lock method and user confirmation method as set forth in claim 40, wherein said step of checking authority of a user is performed by confirming whether any administrator fingerprint code in the data frame transmitted from said electronic card key coincides with any one of the administrator fingerprint codes stored in the data storage part of said door lock device, in addition to said coincidence of the door codes.

42. The door lock method and user confirmation method key as set forth in claims 39, wherein said unauthorized user having passed the door is either an owner of the electronic card key having no authorization to access the door, or a non-owner of the electronic card key.
